(19) United States
(12) Patent Application Publication
(10) Pub. No.: US 2026/0349839 A1
(43) Pub. Date: Nov. 5, 2026

(54) POLICY-DRIVEN COMPUTING RESOURCE CONSOLIDATION WITH MULTI-LEVEL STATES

(71) Applicant: Hewlett Packard Enterprise Development LP, Spring, TX (US)

(72) Inventors: Dejan S. Milojicic, Palo Alto, CA (US); Gourav Rattihalli, Fremont, CA (US); Lin A. Nease, Half Moon Bay, CA (US)

(21) Appl. No.: 19/194,905

(22) Filed: Apr. 30, 2025

(51) Int. Cl. G06F 9/50; G06F 1/3296

(52) U.S. Cl. CPC G06F 9/5094; G06F 1/3296; G06F 9/505

(57) ABSTRACT

According to an implementation, a hierarchical multi-objective policy enforcement system dynamically manages resources across multiple operational states for computing resource consolidation. The system receives user policies prioritizing performance and operator policies prioritizing efficiency and balances these competing objectives through a policy enforcer that communicates with a global cluster manager coordinating multiple cluster-level managers. Computing resources are consolidated proportionally to collocated consumers, enabling shared standby capacity rather than dedicated resources for each consumer. The system transitions resources between states based on current and predicted workload requirements, with different resource distributions for different utilization scenarios.

### BACKGROUND

Computing infrastructures, such as data centers and cloud environments, often operate with varying levels of resource utilization throughout different periods. These infrastructures typically include numerous computing resources, such as servers, storage devices, and networking equipment, which may remain powered on regardless of usage patterns. In many enterprise environments, computing resources can be underutilized during certain periods, with utilization rates sometimes falling below 50% yet still consuming significant amounts of power and contributing to operational costs.

For example, Function-as-a-Service (FaaS) and other virtualized computing environments (e.g., microservices or services) may maintain standby resources for auto-scaling purposes, where additional capacity can be quickly allocated when demand increases. These standby resources are typically kept in an active power state to ensure rapid availability, even when they may not be wanted for extended periods. Computing resource management systems can monitor workload patterns and adjust resource allocation. Still, they may not fully address the power state management of physical hardware across multiple operational states based on predicted usage patterns and multi-stakeholder objectives.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is an implementation of a hierarchical multi-objective policy enforcement system for computing resource consolidation;

FIG. 2 is a block diagram of an implementation computer system that can be used in the hierarchical multi-objective policy enforcement system for computing resource consolidation;

FIG. 3 is an example of a resource allocation diagram showing different levels of resource activation states in a computing infrastructure;

FIG. 4 is a flowchart of an implementation method for dynamic resource management using hierarchical multi-objective policy enforcement;

FIGS. 5A-C illustrate resource distribution diagrams showing an implementation of different allocations of computing resources across operational states based on service pricing tiers or seasonality and trending.

FIGS. 6A-C are resource distribution diagrams showing an implementation of different allocations of computing resources across operational states based on varying utilization levels;

FIG. 7 is a flowchart of a method for hierarchical multi-objective policy enforcement for computing resource consolidation;

FIG. 8 is a flowchart of an implementation method for reactivating consolidated inactivated resources based on resource consumption trending;

FIG. 9 is a flowchart of an implementation method for cost-optimized autoscaling with differentiated pricing based on scaling speed;

FIG. 10 is a flowchart of an implementation method for hierarchical, multi-objective, multi-party resource re/in-activation;

FIG. 11 is a flowchart of an implementation method for hierarchical multi-objective policy enforcement for computing resource consolidation;

FIG. 12 is a flowchart of an implementation method for managing computing resources through dynamic distribution adjustment based on utilization levels; and

FIG. 13 is a flowchart of an implementation method for managing computing resources through proportional consolidation and intelligent reactivation.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the inventive aspects are described primarily in the context of data center computing environments with physical server hardware, it should also be appreciated that these inventive aspects may also apply to cloud computing infrastructures and edge computing deployments. In particular, aspects of this disclosure may similarly apply to virtualized environments, including container-based systems, virtual machine implementations, and hybrid computing architectures that span multiple geographical locations.

In implementations, a hierarchical multi-objective policy enforcement system for computing resource consolidation provides dynamic management of computing resources across multiple operational states. The system addresses the problem of underutilized computing infrastructure, where resources remain fully powered despite low utilization rates. By implementing a hierarchical approach to resource management, the system can balance competing objectives from users and operators while optimizing for performance and sustainability.

Computing resources in data centers and other infrastructure environments often operate at less than 50% utilization yet typically remain fully powered. This results in unnecessary energy consumption and increased operational costs. In the implementations described herein, a system enables computing resources to transition between different power states (e.g., active, standby, sleep, and shutdown) based on current and predicted workload requirements. These transitions allow for significant energy savings while maintaining the ability to scale resources when desired.

The system can include a policy enforcer that receives user and operator policies, which may have different and sometimes competing objectives. User policies typically prioritize performance and availability, while operator policies may focus on resource efficiency and sustainability. The policy enforcer can balance these objectives and communicate with a global cluster manager, coordinating multiple cluster-level managers directly controlling computing hardware resources.

In implementations, resources can be consolidated proportionally to the number of collocated consumers with reserved instances for auto-scaling. Rather than maintaining dedicated standby resources for each consumer, the system can allow for shared standby capacity, reducing the overall resource requirements. The system can collect and analyze historical usage data to predict when resources need to be reactivated and in what quantity, enabling proactive resource management.

Different utilization scenarios can trigger different resource distribution patterns in various implementation aspects. For example, during typical utilization, resources can be allocated in balanced proportions across active usage, standby for scale-out, sleep state, and shutdown state. During underutilization, the system can reduce active and standby resources while increasing the proportion of sleep and shutdown states. More resources can be allocated to active usage during heavy utilization, with fewer in standby, sleep, and shutdown states.

In various implementations, the system can implement different pricing models based on auto-scaling speed and the level of standby resources maintained. The pricing models can create economic incentives aligned with sustainability goals while maintaining performance guarantees. The system can adapt to workload patterns, time of day, and trending resource usage, allowing operators to optimize for performance and sustainability simultaneously. These and additional details are further discussed below.

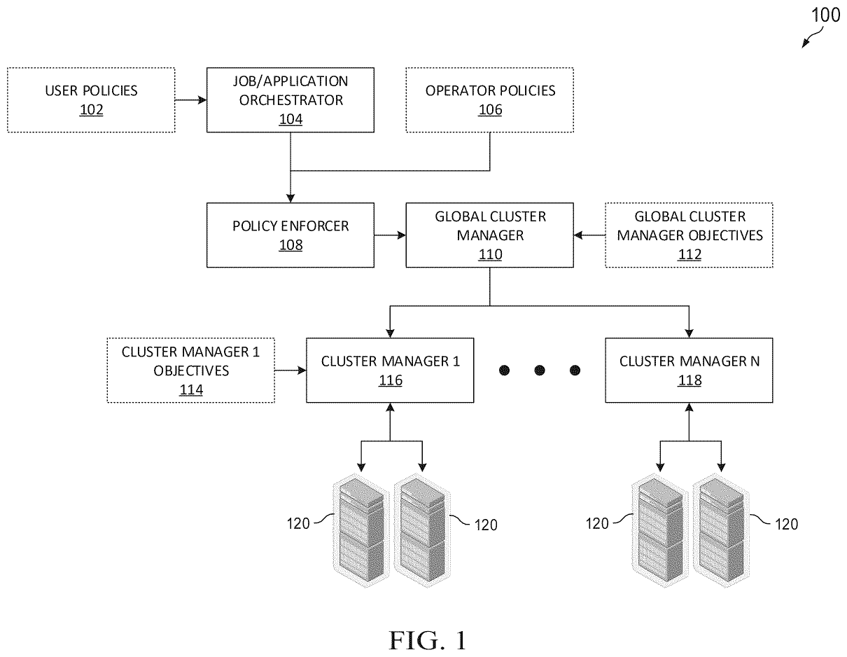

FIG. 1 illustrates an implementation of a hierarchical multi-objective policy enforcement system 100 for computing resource consolidation. Computing infrastructure operators often struggle to effectively optimize for sustainability, with traditional data centers frequently operating at utilization rates below 50%. This results in unnecessary energy consumption and operational costs, as machines that do not need to be active remain powered on. The hierarchical multi-objective policy enforcement system 100 addresses this problem by providing mechanisms to dynamically control the state of infrastructure while conforming to different objectives of users and operators.

The hierarchical multi-objective policy enforcement system 100 includes user policies 102 that provide input to a job/application orchestrator 104. Operator policies 106 and job/application orchestrator 104 provide input to policy enforcer 108, which balances competing objectives from different stakeholders. This multi-objective approach caters to multiple parties, allowing effective management of computing infrastructure for sustainability purposes.

The policy enforcer 108 communicates with a global cluster manager 110, which operates according to global cluster manager objectives 112. These objectives may include user/operator policy tradeoffs and performance considerations. The global cluster manager 110 coordinates multiple cluster managers, including a first cluster manager 116 through an N^{th} cluster manager 118.

Each cluster manager can have its own objectives. For example, the first cluster manager 116 receives the first cluster manager objectives 114, which may include sustainability and performance targets. Each cluster manager directly controls the computing resources 120, which may include servers, storage devices, and networking equipment. These computing resources 120 can be placed in different operational states (e.g., active, standby, sleep, shutdown) based on current and predicted workload requirements, enabling cascaded deactivation for energy savings.

The hierarchical structure enables policy decisions to flow from high-level user and operator requirements down to specific hardware resources while allowing for different objectives at each level of the hierarchy. This architecture facilitates the dynamic management of computing resources across multiple operational states to optimize performance and sustainability. Through these mechanisms, the state of individual systems within the computing infrastructure can be dynamically adjusted by following pre-determined policies, addressing the sustainability challenges faced by traditional data center operations.

The hierarchical multi-objective policy enforcement system can be applied to various use cases that deliver significant operational benefits. For example, in underutilized data centers, common in enterprise environments where utilization rates typically fall below 50%, the system can implement consolidation across the facility to generate energy and cost savings. By identifying underutilized resources and transitioning them to lower power states, such as sleep or shutdown, the system can dramatically reduce power consumption while maintaining the ability to reactivate resources when desired. The approach to resource state management allows organizations to maintain performance and availability while significantly improving sustainability metrics and reducing operational expenses associated with power, cooling, and infrastructure maintenance.

As another example, the system can enable consolidation for individual customer partitions within multi-tenant environments, creating opportunities to add more partitions and increase overall infrastructure efficiency. By analyzing usage patterns across customer workloads and identifying complementary utilization cycles, the system can consolidate standby resources that would otherwise remain idle most of the time. This consolidation can create available capacity for new customers or services without requiring additional physical infrastructure. The policy-driven approach can ensure that each customer's performance requirements are still met while optimizing the underlying resource allocation to maximize efficiency and minimize waste.

As another example, the proposed approaches can be implemented in the context of hardware updates and maintenance activities. The system can consolidate workloads onto one portion of the infrastructure, allowing administrators to update or replace hardware in another section without service disruption. Once the hardware updates are complete, the process can be reversed, with workloads consolidated onto the newly updated section while the remaining infrastructure is refreshed. This rolling update approach can eliminate or minimize downtime during hardware refreshes while ensuring that resources are efficiently utilized. The system's ability to predict workload patterns and proactively manage resource states makes these maintenance activities more predictable and less disruptive to ongoing operations.

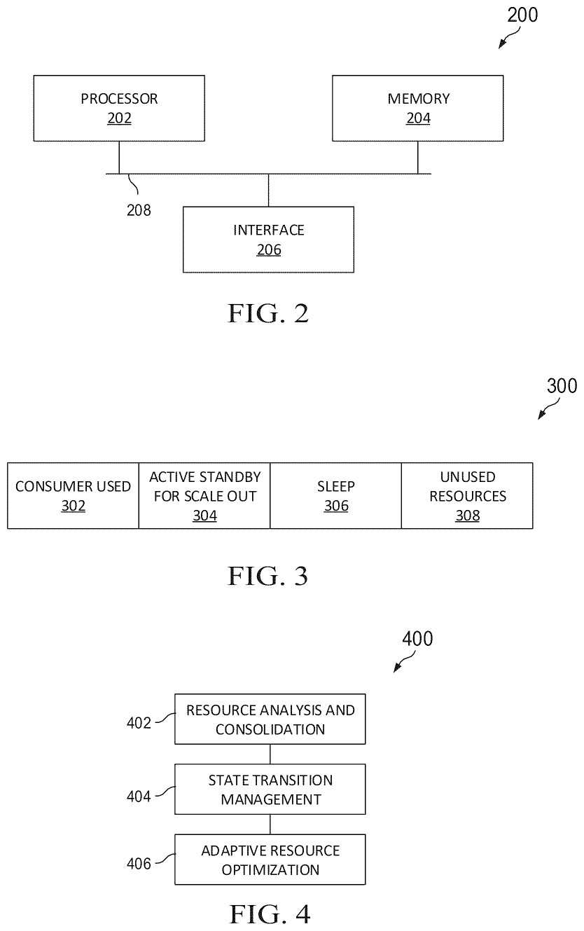

FIG. 2 illustrates a block diagram of an implementation computer system 200 that can be used in the hierarchical multi-objective policy enforcement system for computing resource consolidation. The computer system 200 includes a processor 202, a memory 204, an interface 206, and a bus 208, which may (or may not) be arranged as shown. The processor 202 and memory 204 are coupled to the bus 208, which facilitates communication between the various components of the computer system 200. The interface 206 is also coupled to the bus 208 and provides connectivity for external communications.

Processor 202 may comprise various types of processing hardware circuitry capable of executing instructions for resource management and policy enforcement operations. It can be implemented as a central processing unit (CPU), a Graphics Processing Unit (GPU), a Field-Programmable Gate Array (FPGA), an Application-Specific Integrated Circuit (ASIC), a Digital Signal Processor (DSP), or combinations thereof. In some implementations, the processor 202 may include specialized circuits for monitoring resource utilization and managing power state transitions across multiple computing resources.

Memory 204 may include non-transitory or transitory memory components. Non-transitory memory can include Read-Only Memory (ROM), Flash memory, Electrically Erasable Programmable Read-Only Memory (EEPROM), hard disk drives, solid-state drives (SSD), optical discs, or other persistent storage media. Transitory memory can include Random Access Memory (RAM) such as Dynamic RAM (DRAM), Static RAM (SRAM), or other volatile memory types. Memory 204 may be organized in hierarchical structures, with faster cache memory coupled more directly to processor 202, and larger, slower main memory accessible via the bus 208. Memory 204 can store policy definitions, resource utilization data, historical usage patterns, prediction models, and program instructions for the resource consolidation system.

Different memory types serve various functions in the computer system 200. For example, cache memory can provide high-speed access to frequently used data and instructions. Main memory can offer larger storage capacity at somewhat lower speeds. Non-volatile memory retains data when power is removed, allowing the computer system to persistently store policy configurations and historical usage data for trend analysis.

Interface 206 may facilitate communication with external devices or networks, allowing the computer system 200 to monitor and control multiple computing resources across different clusters. Interface 206 can connect to various peripherals such as displays, input devices, or other computing systems that may be part of the managed infrastructure. Interface 206 may include hardware for network communications to enable coordination between global and local cluster managers.

Bus 208 provides a communication pathway between processor 202, memory 204, and interface 206, enabling data transfer and coordination between these components during policy enforcement and resource management operations. The bus 208 may comprise multiple signal lines for transferring data, addresses, and control signals.

Computer system 200 may include additional components not shown in FIG. 2, such as power management circuitry, cooling systems, telemetry collection hardware, or additional processing units and memory. These components support the computational demands of resource monitoring, workload prediction, and policy enforcement operations, enabling dynamic management of computing resources across multiple operational states for improved sustainability and performance.

FIG. 3 illustrates an example of a resource allocation diagram 300 showing different levels of resource activation states in a computing infrastructure. The diagram depicts four categories of the state of computing resources that the hierarchical multi-objective policy enforcement system can manage.

Consumer-used resources 302 represent actively utilized computing resources that are currently executing workloads. For example, these may include multiple Function-as-a-Service (FaaS) instances (e.g., FaaS₁, FaaS₂, through FaaS_{N}) that are actively processing user requests. Other examples of consumer-used resources may include virtual machine images, container images, or other computing services actively processing data.

Active standby for scale-out resources 304 represents computing resources powered on and ready for immediate use but not currently executing workloads. In a FaaS environment, each FaaS instance traditionally may have its dedicated standby resources for handling sudden increases in request volume. These standby resources are maintained in a ready state to enable rapid scaling when demand increases. The active standby for scale-out resources 304 are typically sold and committed to customers but remain unused until wanted. This category serves as a buffer that allows the system to quickly respond to increased workload demands without the delay associated with powering up or initializing new resources.

Sleep resources 306 represent an intermediate power state where computing resources consume significantly less energy than active or standby resources while maintaining some state information. For FaaS workloads that experience predictable usage patterns, such as higher activity during business hours and lower activity overnight, certain standby resources can be placed in the sleep state during expected low-usage periods. These resources can be brought back to operational status more quickly than completely powered-down resources, providing a balance between energy conservation and reactivation speed.

Unused resources (e.g., shutdown resources 308) represent available computing capacity but are not currently allocated to active workloads, standby, or sleep purposes. In a FaaS environment with multiple instances (e.g., FaaS₁, FaaS₂, through FaaS_{N}), the system can consolidate the standby resources wanted across all instances rather than maintaining separate standby resources for each. This consolidation allows more resources to be placed in the unused category and completely powered down.

To maximize energy conservation, these resources may be placed in the shutdown state, particularly during extended periods of low demand, such as weekends or holidays. The resources in this category can include compute nodes (e.g., CPU, GPU, clusters, supercomputers), storage nodes, VM instances in the cloud, or container instances in the cloud that are not currently needed based on workload predictions and utilization patterns.

Advantageously, the resource allocation approach illustrated in FIG. 3 significantly improves existing resource management systems. In existing approaches, a substantial amount of computing resources remains committed and running at all times, even when not actively used. This results in unnecessary energy consumption and operational costs.

As shown in FIG. 3, implementing the hierarchical multi-objective policy enforcement system with distinct resource states can free up a substantial amount of resources. These freed resources can be placed in energy-efficient states such as sleep or shutdown or reallocated elsewhere to serve other workloads. In implementations, the proportional allocation across these states can be dynamically adjusted based on workload patterns, time of day, and trending resource usage, allowing optimal balance between performance and energy efficiency.

The proposed resource allocation approach builds upon and extends existing solutions in resource management and energy efficiency. Previous approaches have included graph-based representations of data centers that model relationships between hardware components and resource usage patterns, multi-sleep mode scheduling techniques for transitioning servers between power states, fine-grained heterogeneous execution frameworks for allocating tasks across CPUs and specialized hardware accelerators, energy-aware scheduling algorithms, and Graph Neural Networks (GNNs) for predicting resource utilization. While these solutions monitor system metrics in real-time and create models of resource usage patterns to make dynamic allocation decisions, they typically focus on individual aspects of resource management rather than providing a framework for resource state management.

In contrast, the hierarchical multi-objective policy enforcement system disclosed herein advances beyond these approaches by categorizing resources into distinct operational states and managing transitions between them. Unlike previous solutions that may optimize within a given power state or focus primarily on workload placement, the approach discussed herein holistically manages the entire resource pool across multiple power states. This comprehensive approach allows for more substantial energy savings by freeing up resources that remain active or on standby in existing systems. This approach also achieves these power savings without sacrificing performance and the ability to scale out. Advantageously, these freed resources can be placed in energy-efficient states such as sleep or shutdown or reallocated elsewhere to serve other workloads, resulting in improved overall system efficiency while maintaining performance requirements.

The resource allocation model illustrated in FIG. 3 represents a technical implementation addressing specific computing infrastructure management challenges. The system manages physical transitions between operational states through hardware control mechanisms that operate at scale across distributed computing environments. These state transitions involve firmware interactions with physical computing components, including power management integrated circuits, voltage regulators, clock generators, and thermal management systems.

For example, transitioning resources from active standby for scale-out resources 304 to sleep state (e.g., sleep resources 306) involves a series of hardware operations: saving processor state to non-volatile memory, powering down peripheral devices, reducing voltage to memory subsystems while maintaining refresh cycles, and configuring wake-up triggers in hardware interrupt controllers. Similarly, moving resources to shutdown state (e.g., shutdown resources 308) requires controlled power sequencing to prevent data corruption and hardware damage. These operations are executed through, for example, specialized firmware that interfaces directly with hardware power management controllers across numerous devices simultaneously.

The system collects and processes telemetry data from thousands of sensors across the computing infrastructure, including power consumption metrics, temperature readings, memory utilization statistics, network traffic patterns, and processor load measurements. This high-volume data collection occurs at millisecond intervals, generating sizable operational metrics stored in specialized time-series databases optimized for rapid querying and pattern recognition. Advanced analytical algorithms analyze this telemetry data to identify usage patterns and rapidly predict future resource requirements, enabling proactive resource state management.

The implementation includes specialized data structures for tracking resource states and utilization patterns. For example, hierarchical bitmap arrays can be used to maintain the current operational state of each computing resource, while circular buffers can capture rolling utilization metrics with timestamp correlation. The system can employ directed acyclic graphs to model dependencies between resources, ensuring that state transitions occur in the correct sequence to maintain application availability. Communication between system components can employ a lightweight binary protocol optimized for minimal overhead, with heartbeat mechanisms to detect component failures and trigger failover procedures.

FIG. 4 illustrates a flowchart of an implementation method 400 for dynamic resource management using hierarchical multi-objective policy enforcement. The method operates as a continuous cycle, returning from step 406 to step 402 to maintain optimal resource allocation as workload patterns evolve. In various implementations, the method may include additional or fewer steps, or the steps may be performed differently than illustrated.

At step 402, the system monitors resource utilization across multiple computing resources and identifies collocated consumers with reserved resources for auto-scaling. This monitoring can involve collecting telemetry data from various hardware components, including CPU utilization, memory usage, network throughput, storage I/O operations, power consumption metrics, and the like. The system can employ distributed monitoring agents that collect these metrics at configurable intervals (typically seconds to minutes) and transmit the data to centralized analytics components using binary protocols to minimize overhead.

In implementations, the system applies multi-objective, multi-party policy enforcement to balance user requirements (e.g., focused on performance) and operator goals (e.g., focused on efficiency). User policies may specify performance parameters such as maximum response time, minimum throughput, or availability requirements, while operator policies may define energy consumption targets, cost constraints, or sustainability goals.

The policy enforcer can evaluate the potentially competing objectives using, for example, configurable weighting algorithms that can adapt based on time of day, business priorities, energy pricing fluctuations, and the like. Based on this analysis, the system can proportionate (i.e., consolidate) reserved resources to the number of collocated consumers, enabling shared standby capacity rather than maintaining dedicated standby resources for each consumer. The consolidation ratio can be dynamically adjusted based on observed scaling patterns and can vary by resource type, with memory, compute, and storage resources potentially having different consolidation strategies.

This consolidation process may involve analyzing historical usage patterns, current workload distribution, and resource allocation commitments to determine optimal consolidation opportunities. The system can maintain time-series databases of resource utilization that capture seasonal patterns (daily, weekly, monthly) and correlate them with external factors such as business cycles or scheduled events.

In implementations, statistical analysis and machine learning techniques, including time-series forecasting models and anomaly detection algorithms, process this historical data to identify patterns and predict future resource needs with quantifiable confidence levels. The system can identify resources that are consistently underutilized during specific periods and mark them as candidates for consolidation while maintaining sufficient capacity to handle predicted peak loads based on service level agreements and historical scaling behavior.

At step 404, the system selectively transitions computing resources between different operational states based on the consolidation analysis. The system can apply multi-level policies to determine each resource's appropriate power state (e.g., active, standby, sleep, or shutdown). These policies can incorporate, for example, reactivation time requirements, energy savings potential, hardware characteristics, and predicted utilization patterns. The transition decisions can be made by evaluating decision trees or rule-based systems that consider the current state, historical transition patterns, and power management capabilities of specific hardware components. For example, resources that may be desirable in the near term can be placed in a sleep state, while resources unlikely to be sought soon can be placed in a shutdown state.

The determination of “near term” versus “longer-term” can be configurable and may vary by resource type and workload characteristics. For example, compute-intensive workloads with unpredictable scaling patterns might use shorter timeframes (minutes to hours) to define “near term.” In comparison, predictable batch processing workloads might use longer timeframes (hours to days).

The system can implement different sleep states that offer varying power savings and reactivation times. For example, in a system with multiple sleep states, sleep states S₁ through S_{M}, with M being an integer greater than one, sleep state S₁ can be configured to provide the fastest wake-up times but modest power savings, and S_{M} can be configured to offer significant power savings but longer reactivation periods.

In various implementations, the transitions involve hardware-level operations, including saving processor states, configuring wake-up triggers, and executing controlled power sequencing. For sleep states, the system may save CPU register contents to memory, reduce voltage to processors while maintaining memory refresh cycles, disable peripheral devices, and configure hardware interrupt controllers to respond to wake events.

The system can execute a complete power-down sequence for shutdown states that may include gracefully terminating processes, synchronizing data to persistent storage, and configuring power management controllers for scheduled wake-up or network-triggered power-on capabilities.

Through dependency modeling and sequenced state changes, the system can manage these transitions while maintaining application availability. The dependency model can be represented as a directed graph where nodes represent resources and edges represent dependencies, allowing the system to identify the correct order for state transitions and ensure that dependent services remain accessible throughout the transition process.

The system can be configured to implement safeguards to prevent oscillation between power states, such as hysteresis thresholds that require utilization to cross specific boundaries before triggering state changes and minimum duration requirements that prevent rapid cycling between states. The system can monitor the health of resources during transitions and can abort or roll back transitions if anomalies are detected, ensuring system stability and reliability.

At step 406, the system continuously refines resource allocation based on usage trends and predictive analytics. The refinement process operates as a feedback loop incorporating real-time telemetry data, historical patterns, and forecasting models to optimize resource states dynamically. The system can employ time-series analysis techniques, such as autoregressive integrated moving average (ARIMA) models, exponential smoothing methods, and machine learning algorithms such as recurrent neural networks (RNNs) or long short-term memory (LSTM) networks to identify patterns and anomalies in resource utilization data.

This can include aggregating trending data of consumer resource consumption to predict reactivation dynamics (i.e., when and how much capacity will be wanted). The aggregation process can combine utilization metrics across multiple dimensions, such as CPU, memory, network, and storage I/O, creating composite utilization profiles for different resource types. The system can apply statistical techniques to detect seasonal patterns at various time scales (hourly, daily, weekly) and correlate these patterns with external factors such as business hours, scheduled batch processes, or known event calendars. Based on these predictions, the system can proactively reactivate resources from, for example, sleep or shutdown states or further inactivate additional resources as appropriate. The reactivation timing can be calculated to ensure resources are available precisely when desired, accounting for the specific wake-up latency of different hardware components and power states.

In implementations, the system determines optimal reactivation locations based on, for example, energy costs, latency requirements, hardware availability, or a combination thereof. The location selection algorithm can consider geographical factors such as electricity pricing in different regions, local power generation carbon intensity, network topology and associated latency between locations, and current capacity utilization at each site. The system can maintain a weighted scoring model that evaluates potential reactivation locations against configurable criteria, allowing operators to emphasize specific factors based on business priorities. For example, during periods of high energy costs, the system may prioritize locations with lower electricity rates, while during periods of high demand, it may prioritize locations with lower network latency to end users.

In implementations, the system can feature dynamic pricing models proportional to auto-scaling speed (e.g., constant, linear, or quadratic) and minimize resource allocation costs through redirection and location-specific reactivation strategies. The pricing models can reflect the different resource costs associated with various scaling speeds—constant scaling maintains a fixed capacity reserve regardless of demand, linear scaling adjusts capacity proportionally to demand changes, and quadratic scaling accelerates capacity addition as demand increases.

In implementations, customers can select the appropriate scaling model based on performance requirements and budget constraints. The system can implement cost optimization algorithms that continuously evaluate the tradeoffs between maintaining resources in higher-power states for faster availability versus the energy and operational savings of lower-power states. These algorithms can incorporate real-time energy pricing, hardware depreciation costs, and the operational overhead of state transitions to calculate the most cost-effective resource allocation strategy.

The adaptive resource optimization process can include anomaly detection mechanisms that identify unexpected utilization patterns and trigger alerts or automated responses. For example, if resource utilization suddenly spikes beyond predicted levels, the system can rapidly reactivate additional resources while simultaneously analyzing the cause of the deviation to refine future predictions. The system can maintain confidence intervals for its predictions and adjust its conservative or aggressive stance on resource allocation based on the historical accuracy of its forecasts for specific workload types or periods.

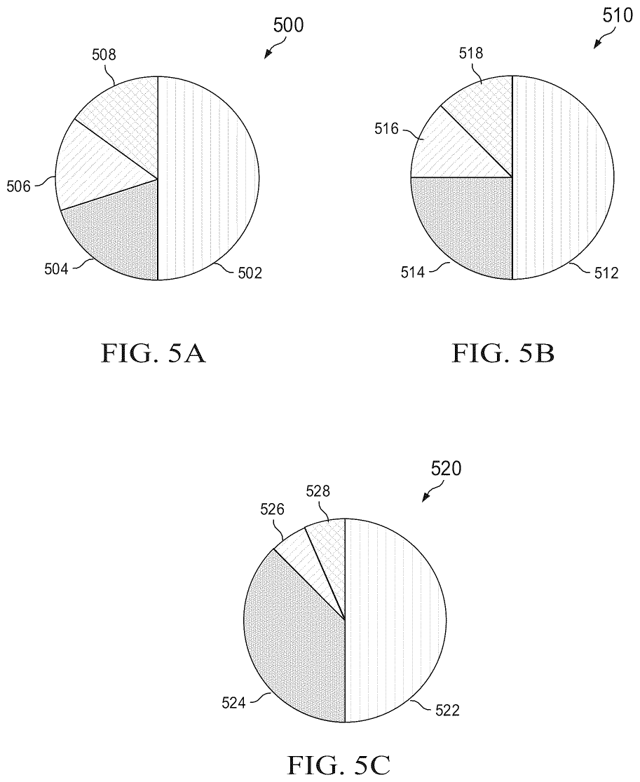

FIGS. 5A-C illustrate resource distribution diagrams showing an implementation of different allocations of computing resources across operational states based on service pricing tiers or seasonality and trending. Each circular diagram represents the entire pool of computing resources available for allocation, with different sections indicating the proportion of resources in each operational state.

FIG. 5A shows a resource distribution diagram 500 corresponding to a basic pricing tier or a weekend period when resource usage is trending downward. In this configuration, the computing resources are divided into four operational states: active resources 502 occupy the largest portion of the diagram, indicating that a significant percentage of resources remain in the fully operational state. Standby resources 504 occupy the next largest segment, providing immediate scale-out capability. Sleep resources 506 and shutdown resources 508 constitute the smallest portions of the resource pool. This distribution reflects a cost-optimized approach where fewer resources are maintained in higher-availability states to minimize operational expenses during periods of lower demand.

FIG. 5B depicts a resource distribution diagram 510 for a premium pricing tier or a nighttime period with moderate resource usage trending. In this configuration, active resources 512 still represent the largest segment. Standby resources 514 form a significantly larger segment than in the basic tier, providing more immediate scale-out capacity for customers willing to pay for enhanced responsiveness. Sleep resources 516 and shutdown resources 518 form a smaller segment compared to the basic tier. This distribution provides a balance between cost efficiency and performance, offering improved scaling capabilities for workloads that require more responsive resource allocation during transitional periods.

FIG. 5C illustrates a resource distribution diagram 520 for an enterprise pricing tier or a workday period when resource usage is trending upward. In this premium configuration, active resources 522 occupy a similar proportion to the premium tier, but standby resources 524 form a substantially larger segment, providing extensive immediate scale-out capacity for mission-critical applications. Sleep resources 526 and shutdown resources 528 form the smallest segment of all three distributions. This distribution prioritizes performance and availability over cost efficiency, ensuring that enterprise customers or peak-time workloads have abundant resources available for immediate scaling with minimal delay during high-demand periods.

The resource distributions illustrated in FIGS. 5A-C can be dynamically adjusted by the hierarchical multi-objective policy enforcement system based on pricing tier and additional factors such as user type, workload classification, time of day, or seasonal patterns. For example, within each pricing tier, different resource distributions may be applied to development environments versus production environments, or to batch processing workloads versus interactive applications.

Similarly, the system can automatically transition between the distributions shown in FIGS. 5A, 5B, and 5C as workload patterns change throughout the day or week. These configurable distribution patterns enable fine-grained optimization of resource allocation across different operational states while maintaining appropriate service levels for various customer segments and workload types.

The resource distributions illustrated in FIGS. 5A-C represent possible configurations and are not intended to be limiting. The specific percentages of resources allocated to each operational state may vary widely in different implementations based on factors such as infrastructure capabilities, workload characteristics, energy costs, and business objectives.

Further, the particular breakout of operational states shown is also non-limiting, as implementations may define additional intermediate states, combine certain states, or utilize entirely different state categorizations depending on the capabilities of the underlying hardware and software.

Similarly, the number and definition of pricing tiers are not limited to the basic, premium, and enterprise examples shown, and the temporal classifications are not limited to weekend, night, and workday periods. Other implementations may include different tier structures, temporal patterns, custom allocation profiles, or dynamically adjustable distributions that evolve based on, for example, real-time conditions. The hierarchical multi-objective policy enforcement system can support numerous alternative configurations and allocation strategies beyond those specifically illustrated, allowing for flexible adaptation to diverse computing environments and business requirements.

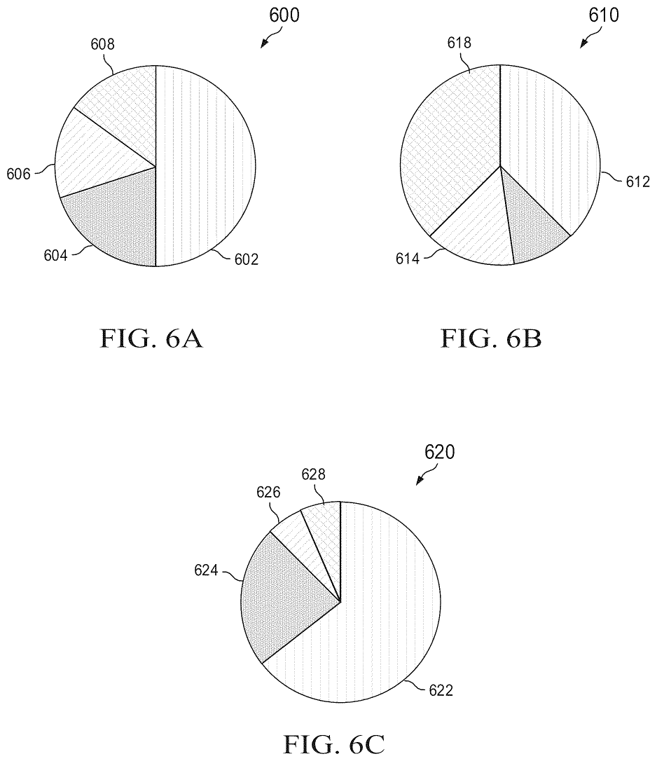

FIGS. 6A-C illustrate resource distribution diagrams showing an implementation of different allocations of computing resources across operational states based on varying utilization levels. Each circular diagram represents the entire pool of computing resources available for allocation, with different sections indicating the proportion of resources in each operational state as the system adapts to changing workload demands.

FIG. 6A shows a resource distribution diagram 600 corresponding to typical utilization patterns. In this configuration, the computing resources are divided into four operational states: active resources 602 occupy the largest portion of the diagram, indicating resources currently executing workloads. Standby resources 604 occupy a moderate segment, providing immediate scale-out capability for normal fluctuations in demand. Sleep resources 606 and shutdown resources 608 constitute smaller portions of the resource pool. This distribution represents a balanced approach for normal operating conditions, maintaining sufficient active and standby resources for current workloads while keeping some resources in lower power states to conserve energy.

FIG. 6B depicts a resource distribution diagram 610 during periods of underutilization. In this configuration, active resources 612 represent a smaller segment than typical utilization, reflecting reduced workload demands. Standby resources 614 also form a smaller segment, as fewer resources are wanted for immediate scale-out capability during low-demand periods. Conversely, sleep resources 616 and shutdown resources 618 form substantially larger segments as the system transitions more resources to lower power states to conserve energy when not wanted. This distribution maximizes energy efficiency during periods of low demand while maintaining a minimal set of active and standby resources to handle current workloads and potential small-scale fluctuations.

FIG. 6C illustrates a resource distribution diagram 620 during periods of heavy utilization. In this high-demand configuration, active resources 622 occupy a significantly larger proportion than typical or underutilization scenarios, reflecting the increased number of resources wanted to handle current workloads. Standby resources 624 form a larger segment than in the underutilization scenario but may be smaller than during typical utilization, as more resources have been activated to handle current demand—although they can also be larger. Sleep resources 626 and shutdown resources 628 form much smaller segments, as the system has transitioned most resources to active or standby states to handle the high workload demands. This distribution prioritizes performance and availability during peak usage periods, ensuring sufficient resources are available to maintain service levels.

The resource distributions illustrated in FIGS. 6A-C demonstrate how the hierarchical multi-objective policy enforcement system can dynamically adjust resource allocations across operational states in response to changing utilization levels. The system can continuously monitor workload demands and transition resources between states to maintain an optimal balance between performance and energy efficiency. During increasing utilization, resources can be progressively moved from shutdown to sleep to standby to active states as wanted. Conversely, resources can be transitioned to lower power states while decreasing utilization to conserve energy when unnecessary.

The specific proportions shown in FIGS. 6A-C represent possible configurations and are not intended to be limiting. The exact distribution of resources across operational states may vary based on factors such as workload characteristics, performance requirements, energy efficiency goals, and the specific capabilities of the underlying hardware. The system may implement more granular transitions between the illustrated scenarios, creating a continuous spectrum of resource distributions that adapt in real time to changing utilization patterns.

The utilization levels (typical, under, and heavy) illustrated in FIGS. 6A-C represent simplified scenarios for the brevity of discussion and are not intended to be limiting. In practice, the system can recognize and respond to many more granular utilization levels along a continuous spectrum rather than three discrete states. Similarly, the operational states (active, standby, sleep, and shutdown) shown in the diagrams are not exhaustive, as implementations may define additional intermediate power states, hybrid states, or specialized states tailored to particular hardware or software capabilities. The hierarchical multi-objective policy enforcement system can support more nuanced and fine-grained resource allocation strategies than those specifically illustrated, allowing for highly responsive adaptation to the full range of utilization patterns encountered in real-world computing environments.

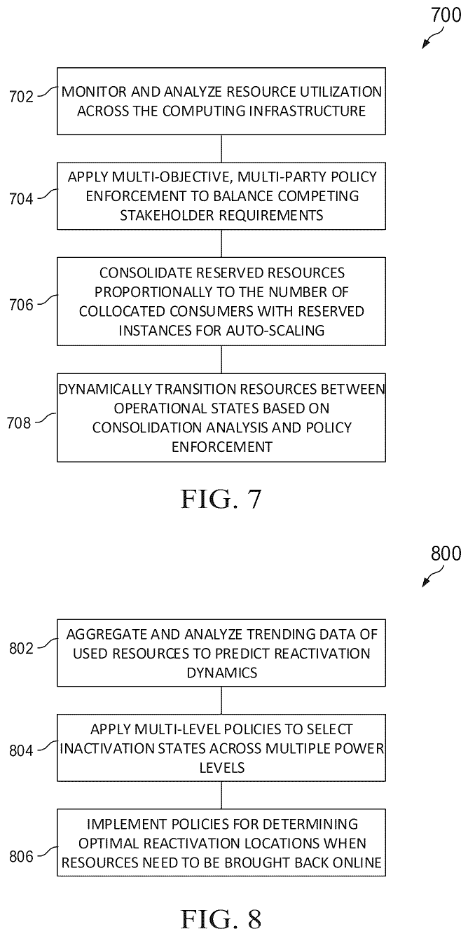

FIG. 7 illustrates a flowchart of an implementation method 700 for hierarchical multi-objective policy enforcement for computing resource consolidation. The method comprises operations that enable dynamic computing resource management across multiple operational states. In various implementations, the method may include additional or fewer steps, or the steps may be performed differently than illustrated.

At step 702, the system monitors and analyzes resource utilization across the computing infrastructure. This can include collecting telemetry data from various computing resources, such as clusters, servers, virtual machines, and containers, and fine-grained resources, such as CPU cores and memory. The system can identify usage patterns and detect underutilized or unused resources for specified periods.

The monitoring process can operate continuously, collecting data at configurable intervals ranging from seconds to minutes depending on the resource type and volatility of workloads. The system can track metrics such as CPU utilization, memory consumption, I/O operations, and network throughput for compute resources. For storage resources, metrics may include read/write operations, latency, and capacity utilization. The collected data may be timestamped and stored in time-series databases optimized for rapid querying and pattern recognition.

In implementations, unused resources may be identified, for example, as resources that have not been sold to customers or as resources that have been sold but are not actively being used, determined through load measurements and utilization metrics. The system can apply configurable thresholds to determine underutilization, which may vary by resource type and service tier. For example, computing resources might be underutilized when CPU utilization remains below 20% for a sustained period, while memory resources might use a different threshold. The system can correlate utilization across related resources to identify patterns that indicate opportunities for consolidation, such as recognizing that several virtual machines with complementary usage patterns could share the same physical host without performance degradation.

The system can employ predictive analytics incorporating historical usage data to forecast future resource requirements, recognizing that specific hardware components may exhibit different usage patterns for the same workload based on user consumption behaviors. These analytics can include time-series analysis techniques to identify cyclical patterns at various scales (hourly, daily, weekly, monthly), regression analysis to identify trends, and machine learning algorithms to recognize complex patterns that may not be apparent through statistical methods alone.

The predictive models can incorporate external factors such as business calendars, scheduled events, and seasonal variations that may impact resource demands. The system continuously refines its predictive models based on observed versus predicted utilization, improving forecast accuracy over time. The system may maintain higher safety margins in its predictions for resources with highly variable or unpredictable usage patterns. In contrast, resources with stable, predictable patterns may operate with tighter margins to maximize efficiency.

At step 704, the system applies multi-objective, multi-party policy enforcement to balance competing stakeholder requirements. In typical data center or cloud operations, two parties are involved: users who consume the resources and operators who provide the resources. These parties often have different and sometimes competing objectives.

The policy enforcement component maintains a hierarchical structure representing global and local objectives, with mechanisms to resolve conflicts when objectives cannot be simultaneously satisfied. The system can, for example, implement a weighted scoring approach where different objectives can be assigned varying importance based on business priorities, contractual obligations, or operational constraints. This weighting can dynamically adjust based on external factors such as peak business hours, energy pricing fluctuations, or critical business events.

Typically, users prioritize performance metrics such as low latency, high availability, and rapid scaling, while operators focus on resource efficiency, energy conservation, and cost management. The system can evaluate these different objectives and enforce policies that optimize for both requirements, creating a balance that satisfies service-level agreements while improving overall infrastructure efficiency.

User policies may specify performance parameters such as maximum response time (e.g., 99th percentile latency under 100 ms), throughput requirements (e.g., minimum transactions per second), or availability targets (e.g., 99.99% uptime). Operator policies may define energy consumption targets (e.g., maximum kilowatt-hours per day), cost constraints (e.g., budget limitations for cloud resources), or sustainability goals (e.g., carbon emission targets). The system can translate these high-level objectives into specific resource allocation decisions and operational state transitions.

When making allocation decisions, the policy enforcement mechanism can consider various factors, including time of day, workload characteristics, business priorities, and resource costs. For time-sensitive workloads, the system may prioritize performance during business hours while emphasizing efficiency during off-hours. For batch processing workloads with flexible completion deadlines, the system may schedule execution during periods of lower energy costs or when renewable energy sources are more available.

The policy engine can implement rule-based decision trees, constraint satisfaction algorithms, or optimization techniques that evaluate potential resource allocation scenarios against the defined objectives. When perfect satisfaction of all objectives is not possible, the system can apply configurable resolution strategies such as prioritization hierarchies, compromise solutions that partially satisfy multiple objectives, or time-sharing approaches that alternate between prioritizing different objectives. The policy enforcement component can maintain audit trails of decisions and rationales, enabling retrospective analysis and continuous improvement of the policy framework.

At step 706, the system consolidates reserved resources proportionally to the number of collocated consumers with reserved instances for auto-scaling. Rather than maintaining dedicated standby resources for each consumer, the system can identify opportunities to share standby capacity across multiple consumers, reducing the total resources wanted for scale-out capability.

For example, in a cloud environment hosting five collocated Function-as-a-Service (FaaS) instances, each FaaS instance can include ten standby servers for auto-scaling during peak demand periods. Without consolidation, this configuration would necessitate maintaining fifty dedicated standby servers across all consumers. The hierarchical multi-objective policy enforcement system can analyze historical usage patterns across these consumers and determine that these FaaS instances rarely need to scale simultaneously. As an illustrative example, through statistical analysis of scaling events, the system may determine that at most two of the five consumers (approximately 40%) typically necessitate scaling resources at any given time. Based on this analysis, the system can proportionate the standby capacity to the actual concurrent scaling needs. Accordingly, instead of maintaining fifty dedicated standby servers, the system can create a shared pool of twenty standby servers that can be dynamically allocated to any FaaS instance when needed. This consolidation approach, proportional to the number of consumers that typically need concurrent scaling, results in a 60% reduction in required standby resources while meeting all auto-scaling requirements for the collocated consumers.

In implementations, the consolidation algorithm analyzes statistical properties of scaling events across multiple consumers to determine the optimal shared standby capacity. For example, if historical data shows that 30% of consumers typically require scale-out capacity simultaneously, the system can maintain significantly fewer standby resources than would be wanted if each consumer had dedicated capacity. The system can implement statistical multiplexing principles, similar to those used in telecommunications networks, to determine the appropriate level of shared capacity to satisfy scaling requirements with a configurable probability (e.g., 99.9% of scaling requests can be satisfied immediately).

This consolidation process can involve defining resource pools and moving resources between these pools based on current and predicted requirements. The system can analyze which resources can be safely consolidated without impacting performance guarantees, considering factors such as historical scaling patterns, correlation between consumers'peak usage times, and the specific requirements of different application types.

The system can maintain multiple resource pools with different characteristics: hot pools containing active resources, warm pools with standby resources that can be activated quickly, cool pools with resources in sleep states that require moderate activation time, and frozen pools with shutdown resources that require longer activation periods. Resources can be dynamically moved between these pools based on utilization patterns and predictions.

The system can perform correlation analysis to identify consumers with complementary usage patterns (e.g., consumers with peak usage in different time zones or days of the week) that are particularly good candidates for shared standby capacity. The system may maintain additional standby capacity for consumers with highly correlated scaling patterns to handle concurrent scaling events. When determining which resources can share standby capacity, the consolidation algorithm can consider hardware compatibility requirements, network topology constraints, and data locality preferences.

The consolidation ratio—the proportion by which standby resources can be reduced through sharing—can be continuously optimized based on observed scaling behavior. Higher consolidation ratios may be applied for stable workloads with predictable scaling patterns, while volatile workloads with unpredictable scaling requirements may use more conservative ratios.

The system can implement feedback mechanisms that track scaling request satisfaction rates and adjust consolidation parameters to maintain service level objectives. If scaling requests cannot be satisfied immediately due to insufficient standby capacity, the system can trigger accelerated activation of resources from sleep or shutdown states and temporarily reduce the consolidation ratio until performance stabilizes.

The consolidation process can consider heterogeneity in resource types, potentially maintaining different consolidation ratios for different resource categories (compute-optimized, memory-optimized, storage-optimized, etc.) based on their specific scaling characteristics and activation times.

At step 708, the system dynamically transitions resources between operational states based on consolidation analysis and policy enforcement. For example, resources that are identified as candidates for consolidation may be moved from active to standby state if they are currently underutilized but may be wanted in the near future.

These transitions involve orchestrating complex hardware and software components to ensure data integrity and service continuity. For compute resources, transitioning to standby may involve migrating active workloads to other resources, quiescing applications, flushing caches, and configuring rapid wake-up triggers. The system can implement transition protocols specific to different resource types, recognizing that storage resources, networking equipment, and compute nodes may require different procedures for safe state changes. Transition decisions can incorporate hysteresis mechanisms to prevent oscillation between states, requiring that utilization metrics cross thresholds for sustained periods before triggering state changes.

Resources already in standby that show continued non-usage may be further transitioned to sleep state and eventually to shutdown state if the predicted future load does not require them. The system can maintain a minimum set of standby resources to enable rapid auto-scaling when desired, with the specific amount determined by policy requirements and service level agreements. These state transitions can be integrated with available workload management systems or operations management systems where dedicated workload managers do not exist.

The system can implement different sleep states with varying power consumption and wake-up latency characteristics. For example, a first sleep state (S₁) can maintain memory contents and processor cache for rapid wake-up but modest power savings, while a third sleep state (S₃) powers down most components except memory for deeper power savings with moderate wake-up times. Full shutdown provides maximum energy savings but requires the longest reactivation time. The system can select the appropriate state based on the predicted time until the resource is again wanted, balancing energy savings against reactivation speed requirements.

In implementations, the system recognizes that certain applications may not be suitable for this approach, such as those that cannot scale out or have dedicated namespaces. In such cases, these can be excluded from the dynamic transition process. The system can maintain a registry of application characteristics and compatibility with different operational states, ensuring that resources hosting state-sensitive applications or those with special hardware requirements are handled appropriately.

When determining state transition eligibility, the system can consider the most restrictive requirements for resources hosting multiple applications or services. The transition process can include comprehensive health checks before and after state changes to verify proper operation. The system can abort the operation and restore the previous state if anomalies are detected during transitions. For critical infrastructure components, the system may implement rolling transitions where a subset of redundant resources change state at any given time, maintaining service availability throughout the process. The system can track transition frequency and duration for each resource, identifying components that consistently fail transitions or take longer than expected to change states and flagging these for maintenance or replacement.

FIG. 8 illustrates a flowchart of an implementation method 800 for reactivating consolidated inactivated resources based on resource consumption trending. The method comprises operations that enable resource state management across multiple power states. In various implementations, the method may include additional or fewer steps, or the steps may be performed differently than illustrated.

At step 802, the system aggregates and analyzes trending data of used resources to predict reactivation dynamics. This can involve collecting and processing historical usage data to determine when particular resources are to be reactivated and in what quantity. The system can implement a multi-layered data collection architecture that gathers utilization metrics from various sources, including hypervisors, container orchestration platforms, application performance monitoring tools, and infrastructure management systems. These metrics can be stored in, for example, time-series databases optimized for pattern recognition and trend analysis, with data retention policies that balance analytical depth against storage requirements. The system can apply statistical techniques such as moving averages, exponential smoothing, and seasonality decomposition to identify underlying patterns in resource consumption that might not be immediately apparent in raw utilization data.

For example, if the system recognizes that usage patterns follow diurnal patterns (somewhat cyclic patterns), as is typical in enterprise cloud services where workloads often correlate with business hours, the system can employ time-series analysis techniques to identify these cyclical patterns at various scales (hourly, daily, weekly) and uses this information to predict future resource requirements. The system can detect and account for multiple overlapping cycles, such as daily business patterns combined with weekly reporting cycles and monthly billing operations.

The system can achieve high prediction accuracy for resources with well-established patterns, often forecasting resource needs hours or days in advance with confidence intervals that narrow as the predicted time approaches. The system can incorporate anomaly detection algorithms that identify deviations from expected patterns, triggering alerts or automated responses when usage trends diverge significantly from predictions. These anomalies can be analyzed to determine if they represent one-time events or emerging new patterns that should be incorporated into future predictions.

The prediction mechanisms can be adjusted based on the resource type and its associated activation time—different resources require different amounts of time to startup and be ready for use. For example, virtual machines may take minutes to initialize, while containers may be ready in seconds. By predicting when workload is likely to arrive, the system can proactively reactivate resources just in time to meet demand, balancing the tradeoff between immediate availability and energy conservation.

The system can maintain a resource activation profile database that records the typical startup times for different resource types across various hardware configurations and load conditions. These profiles can be continuously updated based on observed activation times, allowing the system to refine its predictions over time. For critical workloads with strict performance requirements, the system may apply conservative timing estimates that ensure resources are available slightly before they're wanted. In contrast, non-critical workloads might use more aggressive timing to maximize energy savings.

The system can account for variations in startup time based on the resource's current state—for example, cold starts from a shutdown state versus warm starts from a sleep state—and adjust its reactivation scheduling accordingly.

At step 804, the system applies multi-level policies to select appropriate inactivation states across multiple power levels. The system recognizes that resources can be inactivated in multiple ways with different power consumption profiles and reactivation times. For example, a server could be shut down completely or put in sleep mode, while a container might be paused, checkpointed, or stopped entirely.

Each resource type requires different levels of inactivation—for example, a container doesn't need to be terminated but could be paused, which has a similar effect to shutting down a server in terms of freeing resources while providing faster reactivation. The system can maintain a comprehensive taxonomy of resource types and their available power states, including detailed power consumption specifications, state preservation capabilities, and transition times between states.

These states might include fully active, idle but ready, various sleep states, hibernation, and complete shutdown for computing resources. For storage resources, states might include active, spin-down, and powered off. The system can apply resource-specific transition protocols that ensure data integrity and service continuity during state changes, with specialized procedures for technologies such as traditional servers, hyperconverged infrastructure, containerized environments, and cloud-native platforms.

The system can implement cascading policies where state changes at one level can trigger the evaluation of resources at other levels. For example, pausing a container might trigger a policy to check if the underlying server is now underutilized and could be transitioned to a lower power state. These cascading evaluations propagate through the resource hierarchy, potentially affecting multiple components across the infrastructure.

The system can maintain dependency graphs that model relationships between resources at different levels, ensuring that state transitions at one level don't adversely affect dependent resources at other levels. For example, before transitioning a physical server to a sleep state, the system can verify that all hosted virtual machines and containers are either migrated elsewhere or properly suspended.

The cascading policy framework can include configurable thresholds that determine when utilization changes should trigger reevaluation at adjacent levels, preventing oscillation between states due to minor or transient fluctuations in resource usage. The system can implement different evaluation frequencies for different resource types, with more frequent checks for resources that can transition quickly and less frequent evaluations for resources with longer transition times or higher transition costs.

The selection of the most efficient inactivation state can depend on factors, including the predicted duration of inactivity, the energy savings of different states, and the reactivation time requirements. If a resource is not expected to be wanted for an extended period, shutting it down completely might be more energy efficient. In contrast, resources wanted in the near term might be placed in sleep states that offer faster reactivation at the cost of some continued power consumption.

The system can implement a decision framework that calculates the energy-time tradeoff for each potential state transition, considering the energy saved during the inactive period against the energy cost of the transition itself. This calculation can incorporate the predicted duration of inactivity, the power consumption in each potential state, the energy associated for state transitions, and the performance impact of delayed reactivation.

The system may implement a staged approach for resources with uncertain future demand, initially placing resources in lighter sleep states and progressively transitioning them to deeper sleep or shutdown states as the inactive period extends. The system can continuously refine its decision models based on observed outcomes, learning which inactivation strategies work best for different resource types and usage patterns. The adaptive approach allows the system to optimize its inactivation policies over time, achieving increasingly better balances between energy conservation and performance requirements.

At step 806, the system implements policies for determining optimal reactivation locations when resources need to be brought back online. These location-specific policies recognize that in distributed environments, resources can often be activated in multiple geographic locations or on different physical servers within a data center.

The system can maintain a comprehensive inventory of available resource locations, including their current operational status, capacity, capabilities, and environmental characteristics. This inventory can be continuously updated through automated discovery mechanisms and integration with infrastructure management systems. During reactivation, the system can evaluate potential locations against a multi-dimensional set of criteria to determine the optimal placement. The evaluation process can consider static factors (such as hardware specifications and geographic location) and dynamic factors (such as current utilization, energy pricing, and network conditions) to make context-aware placement decisions that adapt to changing conditions.

Each resource type can have different sets of policies. For example, a server running a set of containers might have server-level and container-level policies that determine which physical server to select for reactivation and in which cluster or data center. The hierarchical policies operate at different levels of granularity, with higher-level policies establishing broad constraints and lower-level policies making specific placement decisions within those constraints.

For containerized applications, policies might consider data locality, affinity rules, anti-affinity constraints, and resource requirements. For virtual machines, policies might evaluate hypervisor compatibility, available memory capacity, and specialized hardware features. The system can implement policy inheritance mechanisms where resources adopt default policies from their parent containers unless explicitly overridden, simplifying policy management in large-scale environments. Policy conflicts can be resolved through configurable resolution strategies that prioritize certain policy types over others or implement compromise solutions that partially satisfy multiple conflicting requirements.

At the infrastructure level, the decision might involve selecting the optimal location based on factors such as current energy costs, local power generation carbon intensity, network latency to users, or hardware availability. The policies can be based on various parameters, including energy efficiency, performance requirements, network latency, and sustainability goals.

The system can integrate with external data sources to obtain real-time information about energy pricing, carbon intensity of power generation, and regional network conditions. The system might preferentially activate resources in regions with lower electricity costs or higher renewable energy availability for energy-aware placement. The system might prioritize locations with lower network latency to end users for performance-sensitive workloads or better connectivity to dependent services. The system can implement geofencing policies that restrict resource activation to specific regions for compliance with data sovereignty regulations or business continuity requirements. The location-based policies can adapt to temporal variations such as time-of-day energy pricing or scheduled maintenance windows, dynamically shifting resource activation patterns to optimize for changing conditions.

In some implementations, the reactivation location policy combines multiple objectives with different weightings, allowing operators to emphasize certain factors based on business priorities or regulatory requirements. The system can continuously evaluate these parameters in real time to make dynamic reactivation decisions that optimize for the current operating conditions and business objectives.

The weighting system allows for flexible policy configuration without requiring complex rule modifications—operators can adjust the relative importance of different factors to shift the system's behavior. For example, during periods of high energy costs, the weight for energy efficiency might be increased, causing the system to prioritize locations with lower power costs. During periods of high user traffic, the weight for performance might be increased, favoring locations with better network connectivity.

The system can implement a feedback loop that monitors the outcomes of placement decisions and adjusts weights based on observed results, enabling continuous optimization. This adaptive approach allows the system to learn from experience and progressively improve its placement decisions. It achieves increasingly better balances between competing objectives such as cost, performance, reliability, and sustainability.

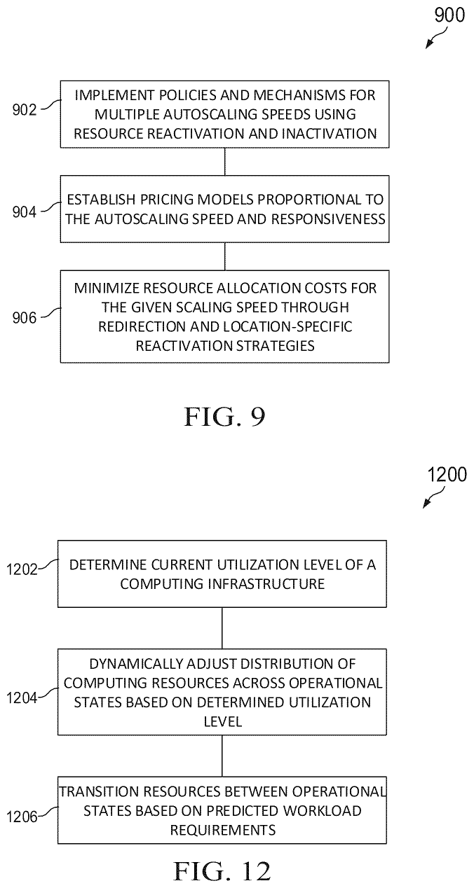

FIG. 9 illustrates a flowchart of an implementation method 900 for cost-optimized autoscaling with differentiated pricing based on scaling speed. The method comprises operations that enable flexible resource scaling while balancing performance requirements against resource efficiency. In various implementations, the method may include additional or fewer steps, or the steps may be performed differently than illustrated.

At step 902, the system implements policies and mechanisms for multiple autoscaling speeds using resource reactivation and inactivation. In implementations, based on Quality of Service (QoS) requirements, users or customers can select different autoscaling speeds, which can be defined in terms of, for example, volume or reactiveness.

The system can provide a policy configuration interface where customers can define their scaling preferences through service profiles that specify parameters such as maximum acceptable latency, minimum throughput requirements, and budget constraints. These high-level requirements can be translated into specific scaling behaviors through policy templates implementing different scaling strategies. For mission-critical applications with strict performance requirements, customers can select high-speed scaling profiles that prioritize immediate resource availability. At the same time, cost-sensitive workloads can use more conservative profiles that optimize resource efficiency at the expense of some performance variability during load spikes.

With volume-based scaling, the system can add servers at a predetermined rate, while reactiveness can determine whether the cluster will be resized conservatively or aggressively in response to load changes.

Volume-based scaling focuses on the quantity of resources added per unit time, such as adding ten servers per minute until demand is satisfied. This approach can provide predictable scaling behavior and resource growth patterns.

Reactiveness-based scaling focuses on how quickly the system responds to load changes. Conservative approaches, for example, require sustained load increases before triggering scaling actions, while aggressive approaches initiate scaling based on early indicators of potential load increases.

The system can implement load prediction algorithms that analyze, for example, real-time metrics, historical patterns, and leading indicators to distinguish between transient spikes and sustained load increases, adjusting scaling behavior accordingly. These algorithms can incorporate multiple data sources, including application-level metrics (requests per second, queue depths), infrastructure metrics (CPU utilization, memory consumption), and external factors (time of day, scheduled events) to make informed scaling decisions.

The system can support multiple scaling profiles, such as constant speed (i.e., fixed rate of resource addition regardless of demand), linear speed (i.e., resource addition proportional to demand increase), and quadratic speed (i.e., accelerating resource addition as demand increases). Constant-speed scaling maintains a fixed rate of resource activation regardless of the magnitude of demand increase, providing predictable scaling behavior but potentially a slower response to large demand spikes. Linear speed scaling adjusts the resource activation rate proportionally to the demand increase rate, providing a balanced approach that scales more aggressively for larger demand changes. Quadratic speed scaling accelerates resource activation as demand increases, enabling rapid response to significant load spikes at the cost of potentially over-provisioning resources. These example profiles can be implemented through, for example, resource state management that coordinates transitions between states (e.g., active, standby, sleep, and shutdown).

The system can implement these (and similar) scaling profiles through resource state transition orchestration that considers, for example, the current state of resources, the time associated for state transitions, the urgency of the scaling requirement, or a combination thereof. For example, during quadratic scaling, the system might simultaneously activate resources from standby, sleep, and shutdown states, prioritizing the fastest-activating resources while initiating parallel activation of slower-activating resources to achieve the desired acceleration in scaling capacity.

The system can implement fully automated autoscaling that dynamically varies speed based on contextual parameters such as performance metrics, time of day (faster scaling during peak business hours), or application criticality. This adaptive approach can ensure critical workloads receive more aggressive scaling during important periods while optimizing resource usage during less critical times.

In various implementations, the automated scaling system implements machine learning models that, for example, continuously analyze performance data, resource utilization patterns, and scaling outcomes to optimize scaling decisions. These models can identify correlations between application behavior, external factors, and optimal scaling strategies, enabling increasingly context-aware scaling over time.

The system can implement a hierarchical decision framework where high-level business policies (such as prioritizing customer-facing applications during business hours) inform mid-level scaling strategies (such as preferring aggressive scaling for specific application types), which in turn determine low-level resource activation decisions (such as which specific resources to activate and in what order). The hierarchical approach ensures that scaling decisions align with business priorities while maintaining the technical flexibility to implement those decisions efficiently across diverse infrastructure environments.

At step 904, the system establishes pricing models proportional to the autoscaling speed and responsiveness. Each level of scaling acceleration can be priced differently, creating a tiered pricing structure that reflects the resource costs and performance benefits of different scaling approaches. For example, in a reactive system, conservative autoscaling (activating resources after detecting sustained load increases) would be priced lower than aggressive autoscaling (preemptively activating resources in anticipation of load).

The pricing structure can be implemented through a multi-dimensional model that considers, for example, the base resource costs and the premium associated with different scaling capabilities. The system can define distinct service tiers such as “Standard” (with conservative scaling), “Premium” (with linear scaling), and “Enterprise” (with aggressive quadratic scaling), each with transparent pricing that reflects the value of the scaling capabilities provided. These tiers can be further customized with scaling speed modifiers that allow customers to fine-tune the responsiveness within each tier, with corresponding adjustments to the pricing. The pricing model incorporates the costs of maintaining resources in different power states, recognizing that standby resources that enable rapid scaling incur higher operational costs than resources in sleep or shutdown states.

The pricing differential acknowledges that reactive systems that scale after a load has arrived may result in temporary performance degradation but use fewer resources, while aggressive approaches that preemptively scale to have resources ready before the load arrives provide better performance but at higher resource cost. This performance-cost tradeoff can be quantified through a detailed analysis of, for example, resource utilization patterns, activation times, and performance metrics across different scaling approaches.

The system can maintain benchmarks demonstrating the performance implications of different scaling speeds for various workload types, helping customers make informed decisions about the appropriate scaling tier for their applications. For transaction-processing applications with strict latency requirements, the performance benefits of aggressive scaling may justify the higher costs, while batch-processing workloads with flexible completion times might benefit more from cost-efficient conservative scaling. The pricing model makes these tradeoffs explicit, allowing customers to select the approach that best aligns with their specific performance requirements and budget constraints.

In various implementations, the system implements a pricing engine that calculates costs based on the selected scaling profile, the resources maintained in various power states, the frequency of state transitions, or a combination thereof. This engine can apply pricing multipliers to different scaling speeds, creating economic incentives and aligning customer choices with their performance and cost priorities.

The pricing engine can integrate with resource monitoring systems to track actual resource usage across different operational states, ensuring accurate cost allocation based on the resources consumed in each state. For constant-speed scaling, pricing can be based on a fixed premium regardless of actual scaling events, reflecting the guaranteed availability of scaling capacity. For linear and quadratic scaling, pricing can incorporate a base component for the scaling capability and a usage-based component that reflects the actual scaling activities performed.

The pricing engine can implement cost allocation algorithms that attribute shared infrastructure costs to different customers based on their scaling profiles and resource usage patterns. These algorithms can consider factors such as the opportunity cost of reserving resources for rapid scaling, the operational overhead of state transitions, the infrastructure investments to support different scaling capabilities or a combination thereof.

The pricing model can incorporate time-based variations, such as peak/off-peak pricing or discounts for accepting slower scaling during specific time windows. These temporal pricing strategies incentivize customers to shift non-time-critical workloads to periods of lower demand, improving overall infrastructure utilization and reducing peak capacity requirements. Customers might receive discounts for accepting slower scaling during maintenance windows or periods of high system-wide demand while paying premium rates for guaranteed rapid scaling during critical business hours.

The system can implement dynamic pricing that adjusts in real time based on current infrastructure utilization, offering lower rates during periods of excess capacity and higher rates during periods of resource contention. These dynamic pricing mechanisms can be implemented through automated bidding systems, where customers can specify their willingness to pay for different scaling speeds under different conditions. This creates a market-based approach to resource allocation that optimizes customer value and infrastructure efficiency.

The pricing model can support commitment-based discounts, where customers receive lower rates by committing to specific scaling profiles for extended periods. This provides predictability for customers and infrastructure operators.

At step 906, the system minimizes resource allocation costs for the given scaling speed through redirection and location-specific reactivation strategies. The system can implement pre-defined policies for autoscaling in multi-site operations, allowing resources to be scaled across different geographical locations at different speeds based on cost and performance considerations.

In some implementations, the location-aware scaling policies incorporate knowledge of the infrastructure topology, such as the network connectivity between locations, data locality requirements, and region-specific capabilities and constraints. The system can maintain a resource map that tracks the distribution of, for example, active, standby, sleep, and shutdown resources across available locations, along with their associated operational costs, energy profiles, and performance characteristics.

This resource map can be continuously updated through automated discovery mechanisms and integration with infrastructure management systems, ensuring that scaling decisions are based on current and accurate information. The system can implement workload placement algorithms that consider the immediate costs of resource activation and the ongoing operational costs at different locations, optimizing for a total cost of operation while maintaining the scaling responsiveness.

For example, if location B has lower operational costs but is currently offline (e.g., in a sleep or shutdown state), the system can calculate whether it would be cost-effective to reactivate location B just in time to move or scale workloads from the more expensive location A. These calculations can incorporate the time associated to reactivate resources at location B, the cost of maintaining the workload at location A during the transition period, the network costs associated with migrating workloads between locations, and the long-term cost savings of operating at the less expensive location.

In various implementations, the system implements predictive activation mechanisms to initiate the reactivation process at location B based on early indicators of scaling requirements at location A. This can ensure that lower-cost resources are available when desired without compromising scaling responsiveness. For workloads with predictable scaling patterns, the system can proactively reactivate resources at lower-cost locations during off-peak hours, when energy costs are typically lower, and reactivation activities have minimal impact on production workloads. The system can consider data sovereignty requirements, compliance constraints, and application-specific dependencies when evaluating cross-location scaling opportunities, ensuring that cost optimization efforts don't compromise regulatory compliance or application functionality.

These calculations can consider, for example, the selected scaling speed, service level agreements, reactivation times, and cost differentials between locations. The system can inventory potential scaling locations with associated costs, activation states, and performance characteristics. During scaling, the system can evaluate multiple scaling strategies across these locations to identify the most cost-effective approach that meets the selected scaling speed requirements. This location-aware scaling can reduce costs while maintaining the promised scaling responsiveness, particularly in environments with substantial cost variations between regions or data centers.

The system can implement a multi-objective optimization framework that balances competing factors such as operational costs, energy efficiency, carbon footprint, network latency, and data locality when making scaling decisions across multiple locations. This framework allows infrastructure operators to express their priorities through configurable weightings influencing the scaling strategy selection process. For example, operators might prioritize carbon footprint reduction during certain periods, cost optimization during others, and performance during peak business hours.

The system can support hybrid scaling strategies that distribute resources across multiple locations based on their specific advantages—for example, maintaining a minimal set of active resources in high-cost, low-latency locations for immediate response to scaling events while activating the bulk of additional capacity in lower-cost locations with slightly higher latency. These hybrid approaches can achieve cost savings while meeting performance requirements for workloads. The system can continuously monitor the outcomes of its scaling decisions and refine its cost models and optimization strategies based on observed results, enabling increasingly efficient resource allocation over time.

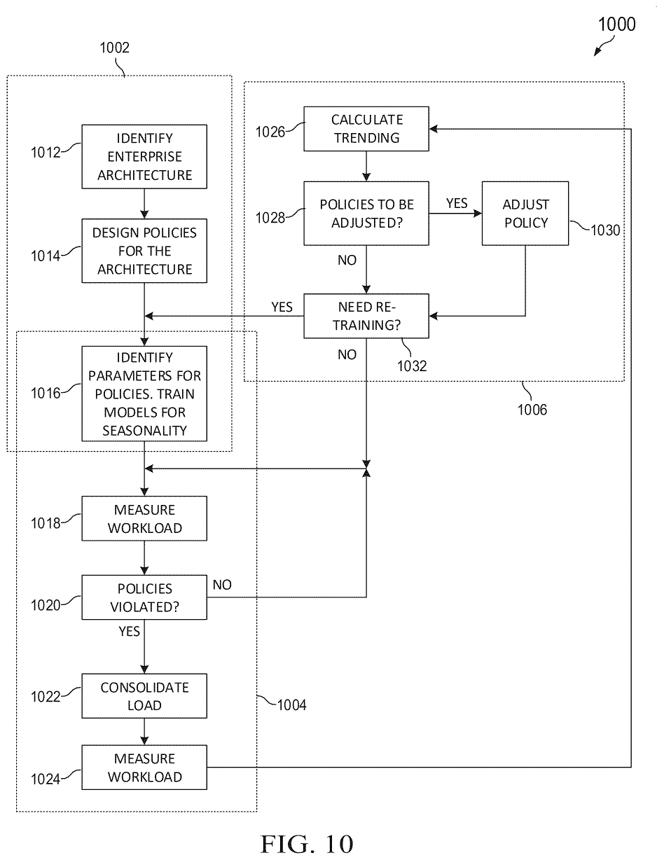

FIG. 10 illustrates a flowchart of an implementation method 1000 for hierarchical, multi-objective, multi-party resource re/in-activation. The method is organized into phases: initialization phase 1002, operation phase 1004, and consolidation/retraining phase 1006. This comprehensive approach enables dynamic computing resource management across multiple operational states while balancing competing objectives from different stakeholders. The method may include additional or fewer steps in various implementations, or the steps may be performed differently than illustrated.

The initialization phase 1002 establishes the foundation for the resource management system by identifying the infrastructure components, designing appropriate policies, and developing predictive capabilities. This phase typically occurs during the system's initial deployment and whenever significant infrastructure or business requirements changes necessitate a fundamental resource management approach reconfiguration. The initialization phase ensures that the system accurately understands the computing environment it manages and appropriate rule sets to govern resource allocation decisions. This phase establishes the parameters and models to guide subsequent operational decisions, setting the stage for efficient and effective resource management.

The operation phase 1004 represents the day-to-day functioning of the resource management system, where it continuously monitors workload patterns, evaluates policy compliance, and implements consolidation actions when desired. This phase can operate as a continuous loop, constantly measuring resource utilization and performance metrics to detect situations that require intervention. When policy violations are identified, the system can take corrective actions through workload consolidation and resource state transitions, followed by verification measurements to confirm the effectiveness of these actions. In the operation phase, the system delivers its value by optimizing resource utilization in real time while maintaining service levels and performance requirements.

The consolidation/retraining phase 1006 focuses on analyzing longer-term patterns, refining policies, and updating predictive models to ensure the system makes optimal decisions as conditions evolve. This phase leverages the accumulated operational data to identify trends, evaluate the effectiveness of current policies, and determine whether adjustments are wanted to improve outcomes. The system can update policy parameters or retrain its predictive models to incorporate new patterns or changing requirements. This adaptive learning capability enables the system to improve its resource management strategies over time, becoming increasingly efficient and effective as it gains experience with the specific characteristics of the computing environment it manages.

At step 1012, the system identifies the enterprise architecture, establishing an understanding of the computing infrastructure components and their relationships. In some implementations, this includes comprehensive discovery and mapping of computing resources, such as servers, storage devices, networking equipment, virtualization platforms, and containerized environments.

In various implementations, the system catalogs hardware specifications, capabilities, power characteristics, and connectivity relationships. This architectural inventory can provide a foundation for subsequent resource management decisions, providing the context to make informed allocation and state transition choices. The identification process may employ automated discovery tools, integration with infrastructure management systems, and manual configuration to ensure an accurate representation of the enterprise architecture.

At step 1014, the system designs policies for the identified architecture, creating the rule sets that govern resource allocation and state transitions. These policies define how resources should be allocated, when they should transition between operational states, and how competing objectives should be balanced. In various implementations, the policy design process incorporates user requirements (e.g., focused on performance, availability, and responsiveness) and operator requirements (e.g., focused on efficiency, sustainability, and cost management).

The system can create hierarchical policy structures that allow for global policies at the infrastructure level, group policies at the cluster or application level, and specific policies for individual resource types. These policies can include rules for resource consolidation, activation thresholds, deactivation criteria, and conflict resolution strategies. The policy design process may involve collaboration between multiple stakeholders to ensure that all business and technical requirements are appropriately represented.

At step 1016, the system identifies parameters for the designed policies and trains models for seasonality, developing the predictive capabilities wanted to anticipate workload patterns and resource requirements. For example, the system can analyze historical workload data to identify cyclical patterns at various time scales (e.g., hourly, daily, weekly, monthly) and correlate these patterns with business activities, external events, and other relevant factors.

In some implementations, machine learning algorithms such as time-series forecasting models, regression analysis, and neural networks are trained on historical data to predict future resource requirements with quantifiable confidence levels. The system can identify parameters influencing resource utilization, such as time of day, day of week, proximity to business events, and external factors like marketing campaigns or seasonal business cycles. These parameters and trained models can enable the system to make proactive resource management decisions rather than merely reacting to current conditions.

At step 1018, the system measures workload across the computing infrastructure, collecting telemetry data that provides visibility into current resource utilization and performance. Continuous monitoring can capture metrics such as CPU utilization, memory consumption, I/O operations, network throughput, power consumption, and application-specific performance indicators.

In some implementations, the measurement process employs distributed monitoring agents that collect data at configurable intervals, with more frequent collection for volatile resources and less frequent for stable ones. The collected metrics can be timestamped, contextualized with metadata about the resource and its environment, and stored in time-series databases optimized for rapid querying and analysis. The workload measurement process can provide the real-time data wanted to detect policy violations, identify consolidation opportunities, and validate the effectiveness of resource management actions.

At step 1020, the system evaluates whether policies have been violated based on the measured workload data. This evaluation can include comparing current resource utilization and performance metrics against the thresholds and conditions defined in the policies. The system can check for various policy violations, such as underutilized resources that should be consolidated, overutilized resources that require additional capacity, resources in inappropriate operational states based on their utilization patterns, or service level agreement breaches.

The policy evaluation process can consider current conditions, recent trends, and predicted future states, allowing the system to proactively address emerging issues before they impact performance or efficiency. If policy violations are detected, the system proceeds to step 1022 for remediation; if no violations are found, the system continues monitoring workloads while periodically checking for trending and policy adjustments.

At step 1022, when policy violations are detected, the system consolidates workloads to optimize resource utilization and address the identified issues. The consolidation process can involve redistributing workloads across the available resources to improve efficiency while maintaining performance requirements. For underutilized resources, the system may migrate workloads to fewer physical hosts, enabling some resources to be transitioned to lower power states. For overutilized resources, the system may activate additional capacity from, for example, standby, sleep, or shutdown states based on the urgency of the need and the available resources.

The consolidation algorithms can consider factors such as workload compatibility, resource requirements, migration costs, and transition times when determining the optimal consolidation strategy. The system can implement the consolidation actions through orchestrated workflows that ensure service continuity during transitions, with health checks before, during, and after each action to verify successful execution.

At step 1024, following consolidation actions, the system measures the workload again to verify the effectiveness of the consolidation and ensure that the actions taken have successfully addressed the policy violations. Generally, the post-consolidation measurement captures the same metrics as the pre-consolidation measurement but focuses particularly on the resources and workloads that were affected by the consolidation actions.

The system can compare the current state with the pre-consolidation and the expected post-consolidation states to evaluate whether the actions achieved their intended effects. If the consolidation is successful, the system proceeds to the trending analysis phase; if issues remain, the system may initiate additional consolidation actions or flag the situation for operator review. This verification step creates a feedback loop that enables the system to learn from the outcomes of its actions and improve future consolidation decisions.

At step 1026, the system calculates trending by analyzing historical and current utilization data to identify patterns and predict future resource requirements. This trending analysis can include time-series forecasting. In some implementations, the trending analysis can incorporate multiple dimensions of resource utilization, workload characteristics, and external factors. The system can apply statistical techniques such as moving averages, exponential smoothing, and seasonality decomposition to identify underlying patterns in resource consumption.

In some implementations, machine learning algorithms detect correlations between metrics and external events, enabling more sophisticated predictions. The trending analysis can consider long-term patterns (such as gradual growth in resource requirements) and short-term fluctuations (such as daily or weekly cycles). The results of this analysis can inform policy adjustments, model retraining decisions, and proactive resource management actions to prepare for anticipated changes in demand.

At step 1028, based on the trending analysis, the system evaluates whether policies should be adjusted to better align with observed patterns and predicted future states. This evaluation can consider factors such as changes in workload characteristics, shifts in usage patterns, emergence of new applications or services, and evolution of business requirements.

The system can identify policies that may no longer be optimal, such as overly aggressive or conservative consolidation thresholds, activation triggers that don't align with actual usage patterns or resource allocation strategies that don't reflect current priorities. If the system determines that policy adjustments are wanted, it proceeds to step 1030; otherwise, it continues to the retraining evaluation step at step 1032. The continuous policy evaluation ensures that the resource management approach remains aligned with current conditions and requirements rather than becoming outdated as the environment evolves.

At step 1030, when policy adjustments are wanted, the system modifies policy parameters to better align with observed patterns and optimize resource management outcomes. These adjustments may include changing utilization thresholds that trigger state transitions, updating consolidation ratios based on observed scaling patterns, modifying the weighting of different objectives in multi-objective policies, or adjusting the timing of proactive resource activations based on refined predictions.

In various implementations, the policy adjustment process is incremental, making targeted changes to specific parameters rather than wholesale policy replacements to ensure stability and predictability in the system's behavior. The adjustments can be applied according to the hierarchical policy structure, with changes potentially affecting global policies, group policies, or specific resource policies depending on the scope of the observed patterns. After implementing policy adjustments, the system can evaluate whether model retraining is wanted to complement the policy changes.

At step 1032, the system evaluates whether retraining of the predictive models is necessary based on the trending analysis and any policy adjustments made. This evaluation can consider factors such as the accuracy of recent predictions compared to actual outcomes, the emergence of new patterns not captured by the current models, significant changes in the infrastructure or workload characteristics, or the elapsed time since the last retraining. If the system determines that retraining is wanted, the process flows back to step 1016 to update the models with new data and potentially revised parameters. If no retraining is wanted, the process returns to the operational phase to continue monitoring and managing the infrastructure. The selective retraining approach ensures that the predictive models remain accurate and relevant without unnecessary computational overhead from constant retraining.

The cyclical process illustrated in FIG. 10 enables continuous resource allocation optimization across multiple operational states while balancing competing objectives from different stakeholders. By separating the workflow into distinct initialization, operation, and consolidation/retraining phases, the system can provide a structured approach to resource management that combines reactive responses to immediate conditions with proactive preparation for anticipated future states. Integrating policy enforcement, workload measurement, consolidation actions, trending analysis, and adaptive learning creates a comprehensive framework for sustainable and efficient computing resource management that can adapt to changing requirements and conditions over time.

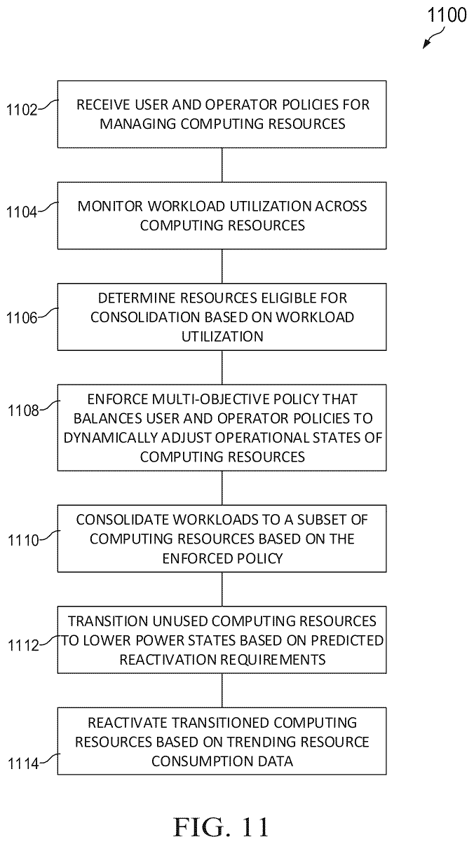

FIG. 11 illustrates a flowchart of an implementation method 1100 for hierarchical multi-objective policy enforcement for computing resource consolidation. The method provides an approach to dynamic resource management that optimizes performance and energy efficiency through intelligent state transitions. The method may include additional or fewer steps in various implementations, or the steps may be performed differently than illustrated.

The method illustrated in FIG. 11 provides a comprehensive framework for dynamic resource management that optimizes performance and energy efficiency. By intelligently transitioning resources between operational states based on current and predicted requirements, the system can significantly reduce energy consumption and operational costs while maintaining the ability to scale resources when desired. The continuous refinement of predictive models and policies ensures that the system becomes increasingly effective over time as it learns from observed patterns and outcomes.

At step 1102, the system receives user and operator policies for managing computing resources. Typically, user policies prioritize performance metrics such as low latency, high availability, and rapid scaling, while operator policies focus on resource efficiency, energy conservation, and cost management. The system can assign different weights to these policies based on various factors, including time of day, allowing performance to be prioritized during business hours while emphasizing efficiency during off-hours. This dynamic weighting approach enables the system to adapt its resource management strategy to align with changing business priorities throughout the day.

At step 1104, the system monitors workload utilization across computing resources. This monitoring process can involve collecting telemetry data from various hardware components, including CPU utilization, memory usage, network throughput, and storage I/O operations. The system can track these metrics continuously, storing the data in time-series databases that enable real-time analysis and historical pattern recognition. This comprehensive monitoring provides the foundation for all subsequent resource management decisions.

At step 1106, the system determines resources eligible for consolidation based on the workload utilization. This determination can involve analyzing current utilization metrics and historical usage patterns to identify resources that are consistently underutilized during specific periods. By recognizing cyclical patterns in resource usage, the system can make informed predictions about which resources can be safely consolidated without impacting performance. The analysis can consider individual resource utilization and correlations between resources that might indicate opportunities for more efficient allocation.

At step 1108, the system enforces a multi-objective policy that balances user and operator policies to dynamically adjust the operational states of the computing resources. The policy enforcement mechanism can evaluate the potentially competing objectives using configurable weighting algorithms that can adapt based on various factors. When perfect satisfaction of all objectives is not possible, the system can apply resolution strategies such as prioritization hierarchies or compromise solutions that partially satisfy multiple objectives. The system can maintain audit trails of these decisions to enable continuous improvement of the policy framework.

At step 1110, the system consolidates workloads to a subset of the computing resources based on the enforced policy. This consolidation process involves redistributing workloads across the available resources to improve efficiency while maintaining performance requirements. The system may migrate workloads to fewer physical hosts for underutilized resources, enabling some resources to be transitioned to lower power states. The consolidation algorithms consider factors such as workload compatibility, resource requirements, migration costs, and transition times when determining the optimal consolidation strategy.

At step 1112, the system transitions unused computing resources to lower power states based on predicted reactivation requirements. These lower power states can include (but are not limited to) standby, sleep, and shutdown states, each offering different tradeoffs between energy savings and reactivation speed. The system can implement a staged approach to these transitions, initially placing resources in lighter sleep states and progressively transitioning them to deeper sleep or shutdown states as inactive periods extend. This approach minimizes the risk of performance impacts while maximizing energy savings for resources that remain unused for extended periods.

At step 1114, the system reactivates transitioned computing resources based on trending resource consumption data. The system analyzes historical and current utilization patterns to predict when resources are to be reactivated and in what quantity. When reactivating resources, the system can select optimal reactivation locations based on energy costs, latency requirements, hardware availability, or a combination thereof. This location-aware reactivation strategy ensures that resources are brought online in the most cost-effective and performance-appropriate locations. Throughout this process, the system continuously refines its predictive models based on observed versus predicted utilization, improving forecast accuracy over time and enabling increasingly efficient resource management.

The system can implement different pricing models based on auto-scaling speed and the level of standby resources maintained, creating economic incentives that align with performance requirements and sustainability goals. These pricing models reflect the different resource costs associated with various scaling speeds and standby levels, allowing customers to select the approach that best meets their specific needs while encouraging efficient resource utilization.

FIG. 12 illustrates a flowchart of an implementation method 1200 for managing computing resources through dynamic distribution adjustment based on utilization levels. The method enables efficient resource allocation across operational states while maintaining appropriate service levels for different utilization scenarios. The method may include additional or fewer steps in various implementations, or the steps may be performed differently than illustrated.

The system can optimize performance and energy efficiency by dynamically adjusting the distribution of resources across operational states and intelligently transitioning resources between states. This approach ensures that computing resources are allocated appropriately for current conditions while maintaining the flexibility to respond quickly to changing demands. The continuous monitoring and adjustment process enables the system to maintain optimal resource allocation as workload patterns evolve.

At step 1202, the system determines a current utilization level of a computing infrastructure. This determination can involve analyzing telemetry data collected from computing resources, including CPU utilization, memory consumption, I/O operations, network throughput, or a combination thereof. The system processes this data to categorize the current state into different utilization levels (e.g., typical utilization, underutilization, or heavy utilization). This categorization serves as the foundation for subsequent resource allocation decisions, enabling the system to respond appropriately to changing workload demands. The system can employ analytics to distinguish between transient spikes and sustained changes in utilization, ensuring that resource allocation adjustments are made when genuine shifts in workload patterns are warranted.

At step 1204, the system dynamically adjusts the distribution of computing resources across operational states based on the determined utilization level. This adjustment follows different patterns depending on which utilization level has been identified. When the system determines a typical utilization level, it can allocate a balanced distribution with a first proportion of resources to, for example, active Function-as-a-Service (FaaS) usage, a second proportion to active standby for scale-out, a third proportion to sleep state, and a fourth proportion to shutdown state. This distribution provides sufficient active and standby capacity for normal operations while keeping some resources in lower power states to conserve energy.

When the system determines an underutilization level at step 1204, it can reduce the proportion of resources allocated to active FaaS usage and active standby for scale-out while increasing the proportion of resources in sleep state and shutdown state. This redistribution maximizes energy efficiency during periods of low demand while maintaining a minimal set of active and standby resources to handle current workloads and potential small-scale fluctuations. The system ensures that a minimum set of standby resources is maintained to enable rapid auto-scaling when desired, with the specific amount determined by policy requirements and service level agreements. This minimum standby capacity ensures that the system can respond quickly to unexpected increases in demand, even during periods of general underutilization.

Conversely, when the system determines a heavy utilization level at step 1204, it can increase the proportion of resources allocated to active FaaS usage while reducing the proportions of resources in active standby for scale-out, sleep state, and shutdown state. This distribution prioritizes performance and availability during peak usage periods, ensuring sufficient resources are available to maintain service levels under high-demand conditions. The system may implement different pricing tiers corresponding to these different resource distributions, with higher pricing tiers providing larger proportions of resources in active and standby states to support mission-critical applications that require immediate scaling capability.

At step 1206, the system transitions resources between the operational states based on predicted workload requirements. These transitions can involve executing hardware-level operations, including saving processor states, configuring wake-up triggers, implementing controlled power sequencing, or a combination thereof. The system can implement safeguards to prevent oscillation between power states, including hysteresis thresholds that require utilization to cross specific boundaries before triggering state changes. These thresholds ensure that resources don't rapidly cycle between states due to minor or transient fluctuations in utilization, which could reduce efficiency and potentially impact hardware reliability.

The system can identify resources that cannot be transitioned between operational states due to application requirements and exclude these resources from dynamic state management. This exclusion ensures that the dynamic resource allocation process does not adversely affect state-sensitive applications or those with special hardware requirements. For the resources that can be transitioned, the system can maintain a registry of their characteristics and compatibility with different operational states, allowing for informed decisions about which resources to transition and when.

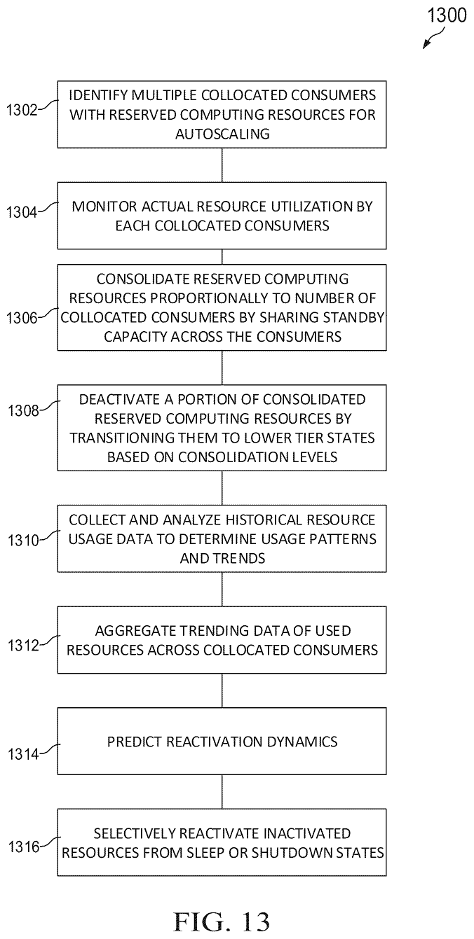

FIG. 13 illustrates a flowchart of an implementation method 1300 for managing computing resources through proportional consolidation and intelligent reactivation. The method enables efficient resource utilization while maintaining appropriate scaling capabilities for multiple consumers. The method may include additional or fewer steps in various implementations, or the steps may be performed differently than illustrated.

The method provides an approach to resource management that optimizes efficiency through proportional consolidation while maintaining appropriate scaling capabilities through intelligent reactivation. By sharing standby capacity across multiple consumers and proactively managing resource states based on predicted requirements, the system can significantly reduce resource consumption without compromising performance or availability. The continuous monitoring, analysis, and prediction process enables the system to adapt to changing usage patterns over time, ensuring that resource allocation remains optimal as requirements evolve.

At step 1302, the system identifies multiple collocated consumers with reserved computing resources for auto-scaling. This identification process can involve mapping the relationships between consumers (such as Function-as-a-Service instances, virtual machines, or containerized applications) and their associated reserved resources. The system catalogs these relationships to establish an understanding of how resources are currently allocated and reserved across the computing environment. This identification serves as the foundation for subsequent consolidation decisions, enabling the system to recognize resource-sharing opportunities among consumers with compatible requirements and usage patterns.

At step 1304, the system monitors actual resource utilization by each collocated consumer. This monitoring can involve collecting telemetry data about how each consumer uses its allocated resources over time. The system can track metrics such as CPU utilization, memory consumption, network throughput, and storage operations, creating a profile of each consumer's resource usage patterns. The system can implement statistical multiplexing principles to determine an appropriate level of shared capacity that satisfies scaling requirements with a configurable probability. This approach, similar to techniques used in telecommunications networks, allows the system to calculate the minimum shared capacity wanted to meet scaling requirements with a specified confidence level, such as ensuring that 99.9% of scaling requests can be satisfied immediately.

At step 1306, the system consolidates the reserved computing resources proportionally to the number of collocated consumers by sharing standby capacity across the consumers. Rather than maintaining dedicated standby resources for each consumer, the system can create a shared pool of standby capacity that can be used by any consumer when desired. The consolidation ratio—the proportion by which standby resources can be reduced through sharing—can be calculated based on a statistical analysis of historical scaling patterns and the correlation between consumers'peak usage times. The system can perform correlation analysis to identify consumers with complementary usage patterns that are particularly good candidates for shared standby capacity. For example, consumers with peak usage in different time zones or on different days of the week can often share standby capacity with minimal risk of concurrent scaling demands.

As an illustrative example, consider a data center hosting three enterprise applications as collocated consumers: a customer-facing e-commerce application requiring fifteen standby servers for handling shopping traffic spikes, an internal analytics platform needing ten standby servers for report generation peaks, and a batch processing system reserving twelve standby servers for end-of-day processing. Without consolidation, these applications necessitate thirty-seven dedicated standby servers to meet their auto-scaling needs. According to the implementations disclosed, the system can perform correlation analysis of historical usage patterns and discover highly complementary peak usage times. For example, it may determine that the e-commerce application peaks during daytime shopping hours (9 am-6 pm), the analytics platform experiences highest demand during morning report generation (7 am-10 am), and the batch processing system primarily scales during overnight processing (11 pm-3 am). Based on this correlation analysis, the system calculates that at most 40% of the total standby capacity is needed at any given time. The system then consolidates the reserved computing resources proportionally by creating a shared standby pool of fifteen servers (approximately 40% of the original thirty-seven) that can be dynamically allocated to any of the three consumers based on current demand. This consolidated pool enables any single application to utilize the entire standby capacity during its peak period, with resources becoming available to other applications when demand normalizes. The system can continuously refine this consolidation ratio based on observed scaling behavior, adjusting the size of the shared pool if scaling patterns change over time.

The system can maintain resource pools with different characteristics, including hot pools containing active resources, warm pools with standby resources, cool pools with resources in sleep states, frozen pools with shutdown resources, or a combination thereof. Resources can be dynamically moved between these pools based on utilization patterns and predictions, with different movement strategies applied to different resource types based on their activation characteristics and requirements. This pool-based approach provides a structured framework for managing resources across different operational states while maintaining appropriate service levels for various consumer types.

At step 1308, the system deactivates a portion of the consolidated reserved computing resources by transitioning them to sleep or shutdown states based on consolidation levels. The system can implement cascading policies, where state changes at one level trigger evaluation of resources at other levels. For example, when containers or virtual machines are consolidated, the system can evaluate whether the underlying physical servers can also be transitioned to lower power states. These cascading evaluations propagate through the resource hierarchy, potentially affecting multiple components across the infrastructure. The system can calculate an energy-time tradeoff for each state transition, weighing the energy saved during inactive periods against the energy costs of transitions. This calculation can incorporate factors such as the predicted duration of inactivity, the power consumption in different states, and the energy associated for state transitions.

At step 1310, the system collects and analyzes historical resource usage data to determine usage patterns, trends, or a combination thereof. This analysis can involve applying data mining and pattern recognition techniques to identify cyclical patterns, growth trends, and correlations in resource usage across different time scales. The system can identify daily, weekly, and seasonal patterns in resource utilization, as well as longer-term growth or decline trends that might indicate changing requirements over time. This historical analysis provides the context wanted to make informed predictions about future resource requirements, enabling proactive rather than reactive resource management.

At step 1312, the system aggregates trending data of used resources across the collocated consumers. This aggregation combines utilization data from multiple consumers to identify patterns that might not be apparent when looking at individual consumers in isolation. By analyzing the collective behavior of all consumers, the system can identify opportunities for resource sharing and optimization that span multiple consumers. The aggregated trending data provides a comprehensive view of resource utilization across the entire computing environment, enabling more effective resource allocation decisions than would be possible with consumer-specific analysis alone.

At step 1314, the system predicts reactivation dynamics comprising determining when resources are to be reactivated and in what quantity based on the aggregated trending data. This prediction can use time-series forecasting techniques to project future resource requirements based on historical patterns and current trends. The system can calculate the timing of anticipated demand increases and the quantity of resources wanted to meet that demand. These predictions incorporate confidence intervals that narrow as the predicted time approaches, allowing the system to adjust its reactivation strategy as predictions become more certain.

At step 1316, the system selectively reactivates inactivated resources from sleep or shutdown states according to the predicted reactivation dynamics before anticipated demand increases. This proactive reactivation ensures that resources are available precisely when desired, without the performance penalty that would result from reactivating resources after demand has already increased. The system schedules reactivations based on the specific wake-up latency of different resource types, ensuring that each resource completes its activation process just in time to meet the anticipated demand. This timing optimization maximizes energy savings while maintaining performance, striking an optimal balance between efficiency and responsiveness.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense. Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A system for managing computing resources, comprising:
a non-transitory memory storage comprising instructions; and
a processor in communication with the non-transitory memory storage, wherein the processor executes the instructions to:
identify multiple collocated consumers with reserved computing resources for auto-scaling,
monitor actual resource utilization by each of the collocated consumers,
consolidate the reserved computing resources proportionally to a number of collocated consumers by sharing standby capacity across the multiple collocated consumers,
deactivate a portion of the consolidated reserved computing resources by transitioning them to sleep or shutdown states based on consolidation levels,
collect and analyze historical resource usage data to determine usage patterns, trends, or a combination thereof,
aggregate trending data of used resources across the collocated consumers,
predict reactivation dynamics comprising determining when resources are to be reactivated and in a quantity based on the aggregated trending data, and
selectively reactivate inactivated resources from sleep or shutdown states according to the predicted reactivation dynamics before anticipated demand increases.

2. The system of claim 1, wherein the processor further executes the instructions to implement statistical multiplexing principles to determine an appropriate level of shared capacity that satisfies scaling requirements with a configurable probability.

3. The system of claim 1, wherein the processor further executes the instructions to maintain resource pools with different characteristics, wherein the resource pools comprise hot pools containing active resources, warm pools with standby resources, cool pools with resources in sleep states, frozen pools with shutdown resources, or a combination thereof.

4. The system of claim 1, wherein the processor further executes the instructions to perform correlation analysis to identify consumers with complementary usage patterns that are candidates for shared standby capacity.

5. The system of claim 1, wherein the processor further executes the instructions to implement cascading policies, wherein state changes at one level trigger evaluation of resources at other levels.

6. The system of claim 1, wherein the processor further executes the instructions to calculate an energy-time tradeoff for each state transition, wherein calculating the energy tradeoff is based on energy saved during inactive periods against energy costs of transitions.

7. A non-transitory computer-readable media storing computer instructions, that when executed by a processor, cause the processor to perform the steps of:
receiving user policies and operator policies for managing computing resources;
monitoring workload utilization across computing resources;
determining resources eligible for consolidation based on the workload utilization;
enforcing a multi-objective policy that balances the user policies and the operator policies to dynamically adjust operational states of the computing resources;
consolidating workloads to a subset of the computing resources based on the multi-objective policy;
transitioning unused computing resources to lower power states based on predicted reactivation requirements, the lower power states comprising standby, sleep, and shutdown states; and
reactivating transitioned computing resources based on trending resource consumption data.

8. The non-transitory computer-readable media of claim 7, wherein the multi-objective policy assigns different weights to the user policies and the operator policies based on time of day.

9. The non-transitory computer-readable media of claim 7, wherein determining resources eligible for consolidation comprises analyzing historical usage patterns to identify resources that are consistently underutilized during specific periods.

10. The non-transitory computer-readable media of claim 7, wherein transitioning unused computing resources to lower power states comprises implementing a staged approach, the staged approach comprising:
placing resources in lighter sleep states; and
progressively transitioning resources to deeper sleep or shutdown states in response to an extension of inactive periods.

11. The non-transitory computer-readable media of claim 7, wherein the instructions further cause the processor to perform the step of implementing different pricing models based on auto-scaling speed and a level of standby resources maintained.

12. The non-transitory computer-readable media of claim 7, wherein reactivating transitioned computing resources comprises selecting optimal reactivation locations based on energy costs, latency requirements, hardware availability, or a combination thereof.

13. The non-transitory computer-readable media of claim 7, wherein the instructions further cause the processor to perform the step of continuously refining predictive models based on observed utilization.

14. A computer-implemented method for managing computing resources, the method comprising:
determining a current utilization level of a computing infrastructure, the current utilization level comprising a typical utilization level, an underutilization level, and a heavy utilization level;
dynamically adjusting a distribution of computing resources across one or more operational states based on the current utilization level,
wherein, in response to determining a typical utilization level, allocating a first proportion of resources to active Function-as-a-Service (FaaS) usage, service usage, or microservice usage, a second proportion to active standby for scale-out, a third proportion to sleep state, and a fourth proportion to shutdown state;
wherein in response to determining an underutilization level, reducing the proportion of resources allocated to the active FaaS usage and the active standby for scale-out and increasing the proportion of resources in the sleep state and the shutdown state; and
wherein in response to determining a heavy utilization level, increasing the proportion of resources allocated to the active FaaS usage and reducing the proportions of resources in the active standby for scale-out, the sleep state, and the shutdown state; and
transitioning resources between the operational states based on predicted workload requirements.

15. The computer-implemented method of claim 14, wherein determining the current utilization level comprises analyzing telemetry data collected from computing resources comprising CPU utilization, memory consumption, I/O operations, network throughput, or a combination thereof.

16. The computer-implemented method of claim 14, further comprising maintaining a minimum set of standby resources to enable rapid auto-scaling, wherein the minimum set is determined by policy requirements and service level agreements.

17. The computer-implemented method of claim 14, further comprising implementing safeguards to prevent oscillation between power states, the safeguards comprising hysteresis thresholds that require utilization to cross specific boundaries before triggering state changes.

18. The computer-implemented method of claim 14, wherein transitioning resources between operational states comprises executing hardware-level operations, wherein the executing hardware-level operations comprises saving processor states, configuring wake-up triggers, implementing controlled power sequencing, or a combination thereof.

19. The computer-implemented method of claim 14, further comprising implementing different pricing tiers corresponding to different resource distributions, wherein higher pricing tiers provide larger proportions of resources in active and standby states.

20. The computer-implemented method of claim 14, further comprising identifying resources that cannot be transitioned between operational states due to application requirements and excluding the identified resources from dynamic state management.
